(19) United States
(12) Patent Application Publication
(10) Pub. No.: US 2025/0372291 A1
(43) Pub. Date: Dec. 4, 2025

(54) HELBECK ARRAY PLANAR COIL STRUCTURAL UNIT

(71) Applicant: Shenzhen Duoyuan Expansion Environmental Protection Technology Co., Ltd, Shenzhen (CN)

(72) Inventors: Shengqiang Pan, Shenzhen (CN); Xiulan Liao, Shenzhen (CN); Zhiquan Liao, Shenzhen (CN); Yuqi Pan, Shenzhen (CN); Jiaqing Pan, Shenzhen (CN)

(73) Assignee: Shenzhen Duoyuan Expansion Environmental Protection Technology Co., Ltd, Shenzhen, GD (CN)

(21) Appl. No.: 19/301,993

(22) Filed: Aug. 17, 2025

Related U.S. Application Data
(63) Continuation of application No. PCT/CN2025/088413, filed on Apr. 11, 2025.

(30) Foreign Application Priority Data
May 11, 2024 (CN) 202410584237.2
Mar. 19, 2025 (CN) 202510336325.5

(51) Int. Cl. H01F 7/02; H01F 5/00; H01F 5/06

(52) U.S. Cl. CPC H01F 7/0278; H01F 5/003; H01F 5/06; H01F 2005/006

(57) ABSTRACT

The disclosure relates to the technical field of electromagnetic coils, in particular to a Helbeck array plane coil structural unit. The Helbeck array plane coil structural unit includes three substructures: the first substructure, the second substructure and the third substructure. The disclosure adopts the plane electromagnetic coil to form the Helbeck array permanent magnetic field effect, and aims to solve the problems that the existing Helbeck array permanent magnetic structure is difficult to be miniaturized, rigid structure, unable to get rid of the limitation of permanent magnetic materials, difficult to realize the truly sinusoidal distributed magnetic field and low electromagnetic utilization rate.

### CROSS-REFERENCE TO RELATED APPLICATIONS

This application is a continuation of PCT/CN2025/088413, filed on Apr. 11, 2025 and claims priorities of Chinese Patent Applications No. 2024105842372, filed on May 11, 2024, and Chinese Patent Application No. 2025103363255, filed on Mar. 19, 2025, the contents of which are hereby incorporated by reference.

### TECHNICAL FIELD

The disclosure relates to the technical field of electromagnetic coils, in particular to Helbeck array planar coil structural units.

### BACKGROUND

Helbeck permanent magnet array structure can form characteristic magnetic fields such as single strong magnetic surface, uniform strong magnetic field, inner surface magnetic field and outer surface magnetic field, and has been widely used in modern science and technology. However, there are still some factors that restrict application of Helbeck permanent magnet array structure, such as: rigid structure, the need to fix the structure, the cumbersome and difficult miniaturization of the whole structure, the difficulty in realizing sinusoidal magnetic field due to magnetizing technology, and the inability to get rid of the restrictions of permanent magnet materials. According to the fact that the intensity of magnetic field is proportional to the excitation current, electromagnetic coil is an effective means to generate magnetic field and get rid of the limitation of permanent magnet materials. There have been studies at home and abroad on the formation of Helbeck permanent magnet array structure by concentrated winding electromagnetic coil, but there are still rigid structural factors, cumbersome structure and difficulty in miniaturization, and it is difficult to realize sinusoidal magnetic field due to magnetic leakage factors. On the other hand, the magnetic field generated by the commonly used concentrated winding electromagnetic coil is consistent with that of the permanent magnet, and both are double-sided magnetic fields. In practical application, the magnetic conductive materials are usually needed to utilize the magnetic field on the other side to improve the electromagnetic utilization rate, but this increases the iron loss. Therefore, the plane coil structure is used to realize the technical development of the magnetic field effect of Helbeck permanent magnet array, which is of competitive significance to modern science and technology.

### SUMMARY

The purpose of the disclosure is to provide Helbeck array coil structural units, aiming at solving the problems that the existing Helbeck array permanent magnet structure is difficult to be miniaturized, rigid in structure, unable to get rid of the limitation of permanent magnet materials, difficult to realize a truly sinusoidal distributed magnetic field and low in electromagnetic utilization rate.

In order to achieve the above purpose, the disclosure provides the following scheme: the disclosure provides Helbeck array planar coil structural units, including:
three types of substructures: first substructures, second substructures and third substructures;
where, the first substructures and the third substructures are concentric planar spiral coils with opposite magnetic circuits in a vertical direction after being electrified, and the second substructures are plane spiral coils of a spiral center linear arrangement with a horizontal component in a magnetic direction after being electrified; spiral center linear arrangement modes of the second substructures includes a spiral center connecting line arrangement or a spiral center connecting line fitting line being a straight line or an arc arrangement; all spiral outer diameters in the second substructures are same or different; coil layerings of the first substructures, the second substructures and the third substructures include a single-layer planar spiral structure, a double-layer planar spiral structure and a multi-layer planar spiral structure;
coil position arrangement modes of the first substructures, the second substructures and the third substructures include:
spiral centers of the first substructures and the third substructures are located at both ends between coil spiral center connecting lines of the second substructures, and two or more the second substructures are centered on concentric plane spiral centers of the first substructures or the third substructures, and homomagnetic ends are symmetrical arrangement or centrally symmetric arrangement; or, spiral centers of the first substructures and the third substructures are respectively located at two end of a horizontal magnetic circuit formed by one or more the second substructures, and two or more substructures between two ends of a horizontal magnetic circuit formed by multiple the second substructures are heteromagnetic end arrangement;
modes of coil arrangement or lamination into a plane include:
firstly, the first substructures, the second substructures and the third substructures are single-layer planar spiral structures or double-layer planar spiral structures to arrange in a plane;
secondly, end points of connecting lines or fitting lines between spiral centers of the first substructures or the third substructures with double-layer planar spiral structures or multi-layer planar spiral structures and spiral centers of the second substructures are different, and projection points are stacked into a plane;
thirdly, end points of connecting lines or fitting lines between spiral centers of the first substructures or the third substructures with single-layer planar spiral structures and double-layer planar spiral structures, multi-layer planar spiral structures and spiral centers of the second substructures are different, and projection points are stacked into a plane;
fourthly, end points of connecting lines or fitting lines between spiral centers of the first substructures or the third substructures with single-layer planar spiral structures and double-layer planar spiral structures, multi-layer planar spiral structures and spiral centers of the second substructures are same, and projection points are stacked into a plane;
fifthly, end points of connecting lines or fitting lines between spiral centers of the first substructures or the third substructures with single-layer planar spiral structures and double-layer planar spiral structures, multi-layer planar spiral structures and spiral centers of the second substructures are same, and projection points laminate and combine material filling layers to form a plane.
composition of coil structural unit and magnetic field characteristics include:
plane spiral coils of one or more of the first substructures, the second substructures and the third substructures are stacked into a plane or more than two-layer thin-layer structure according to coil position arrangement modes, coil arrangement or lamination into a plane mode, all substructures are connected in series, parallel or series-parallel hybrid mode to form the Helbeck array coil structure units, and a Helbeck permanent magnet array characteristic magnetic field is formed after being electrified, where spiral centers of the first substructures and the third substructures are coil structure unit north and south poles respectively, and north and south poles at two ends of the second substructures and the first substructures and the third substructures form a magnetic circuit connection, and magnetic polarity of unconnected ends of the second substructures is opposite to that of connected ends; spiral central connecting line shapes of the planar coil structural units include a straight line, an arc and a net shape.
coil structural unit connection expansion modes include:
according to the coil position arrangement modes, the coil arrangement or lamination into a plane mode, connection expansion is performed through self-structure or connection expansion is performed through coil expansion structure;
a coil structure unit combination includes linear and netted planar coil structure unit combination formed by self-structure connection expansion or coil expansion structure connection expansion, a planar coil structure unit combination formed by coil structure unit array or nesting, and a three-dimensional coil structure unit combination formed by coil structure unit bending or folding or winding or nesting or stacking;
where magnetic field characteristics of the coil structure unit combination include:
firstly, in-plane line and surface type characteristic magnetic field: linear, zigzag, circular, toroidal, arc-shaped, elliptical, polygonal, and netted plane Helbeck permanent magnet array characteristic magnetic field with magnetic surface located on upper or lower surface of coils;
secondly, three-dimensional structure characteristic magnetic field: Helbeck permanent magnet array characteristic magnetic field with magnetic surface located on inner surface or outer surface or inside or outside coils, and Helbeck permanent magnet array characteristic magnetic field with magnetic surface located on an upper surface or lower surface of a coil stacking surface; Helbeck permanent magnet array characteristic magnetic field with magnetic surface located inside coils includes uniform magnetic field;
insulating materials, or heat dissipation materials, or heat dissipation pipelines, or magnetic conductive materials are stacked or filled above or below or between layers the coil structural units and combinations thereof, so as to improve corresponding insulation performance, heat dissipation performance, magnetic conductivity performance and coil structural regularity performance of the coil structural units;
the coil structural units and combinations thereof are made by printed circuit board method or planar coil splicing method.

Preferably, in the coil position arrangement modes, spiral center positions of the first substructures or the third substructures include end points of a spiral center connection line or a spiral center connection line fitting line or extension line thereof located in one or more the second substructures with heteromagnetic end connection, or a center surrounded by more than two the second substructures with homomagnetic end being symmetrical arrangement or centrally symmetric arrangement.

Preferably, according to the coil position arrangement modes, coil arrangement or lamination into a plane mode, connection expansion being performed by self-structure or coil expansion structure includes: insertion and expansion of the second substructures in same horizontal magnetic circuit with the first substructures or the third substructures as expansion points and unconnected ends of the second substructures as expansion points; insertion and expansion of the second substructures in same horizontal magnetic circuit, and insertion and expansion of the second substructures in heteromagnetic end arrangement mode; the coil expansion structures include the first substructures, the second substructures, the third substructures, the first substructures or combinations of the first substructures or the third substructures with one or more the second substructures, combinations of the first substructures and the third substructures with zero to a plurality of the second substructures.

Where, the planar coil structural units are externally connected with zero second substructure, and more than two planar coil structural units are connected with the magnetic end to form a linear or linear closed-loop or netted coil structure combination, and after being electrified, the Helbeck permanent magnet array characteristic magnetic field is formed. The formed linear, cylindrical or netted coil structure combination can eliminate unnecessary repetitive coils at magnetic pole positions according to actual needs, so as to reduce the lamination thickness of coils at magnetic pole positions and improve the overall coil structure uniformity.

The second substructures are connected with the same magnetic end of second substructures of the Helbeck array planar coil structure unit which is not externally connected with second substructures, so as to increase the number of magnetic poles of the coil structure unit, and through the expansion connection of second substructures, linear closed-loop or netted closed-loop connection or coil structural unit chain or netted expansion of more than two Helbeck array planar coil structure units which are not externally connected with second substructures is realized. Compared with the Helbeck permanent magnet array characteristic magnetic field formed by connecting the same magnetic ends of planar coil structural units of being not externally connected with second substructures, the Helbeck permanent magnet array characteristic magnetic field formed by connecting the same magnetic ends of two or more planar coil structural units of being externally connected with second substructures has the characteristics of thin coil stacking thickness at magnetic pole positions, longer overall magnetic circuit and more magnetic poles in the same plane. In the practical application process, unnecessary repetitive coils at magnetic pole positions can be eliminated as needed to improve the structural uniformity of the whole coil.

Preferably, the second substructures have a magnetic circuit transmission function, magnetic circuit transmission includes equal flux density transmission and flux density convergence/divergence transmission; all spiral outer diameters of the second substructures are different, including spiral outer diameters first increasing and then decreasing, gradient increasing or decreasing. In the coil plane structure unit with reduced gradient of all spiral outer diameters of second substructure, the spiral outer diameter of first substructure is preferably equal to the spiral outer diameter of second substructure, and the spiral outer diameter of third substructure is preferably equal to the spiral inner diameter of second substructure. Under the condition that the inner diameters and turns of each substructure are the same, the greater the ratio of spiral outer diameters, the stronger the ability of magnetic flux density convergence or divergence.

Preferably, second substructure coil layering includes a single-layer planar spiral structure, a double-layer planar spiral structure and a multi-layer planar spiral structure, where the single-layer planar spiral structure is planar spiral coils with linear arrangement of spiral centers of each of spiral units, and the double-layer planar spiral structure is formed by connecting single-layer planar spiral coils with linear arrangement of spiral centers with opposite spiral directions in series or in parallel with same direction, or each of the spiral units is a Z-shaped double-layer planar spiral structure formed by combining an upper ring layer and a lower ring layer; the multi-layer planar spiral structure includes multiple single-layer planar spiral structures or multiple double-layer planar spiral structures in series, parallel or series-parallel combination, or each of the spiral units is a rotating stepped multi-layer planar spiral structure formed different coil layers; and interlayer gaps in the double-layer planar spiral structure or the multi-layer planar spiral structure are filled with insulating materials, heat dissipation materials, heat dissipation pipelines or magnetic conductive materials.

Preferably, each of the spiral units has a Z-shaped double-layer planar spiral structure formed by combining an upper coil layer and a lower coil layer, the upper coil layer and the lower coil layer are respectively planar, spiral centers of all the spiral units are arranged in a linear way, planar projection of the upper coil layer and the lower coil layer of each of the spiral units surrounds a geometric figure, and plane projections of a head end of the upper coil lay and a tail end of the lower coil lay are not coincident; a tail end of an upper coil lay of the spiral unit is connected with a head end of a low coil layer of the spiral unit through an interlayer, and a tail end of a lower coil lay of the spiral unit is connected with a head end of an upper coil layer of a next spiral unit through an interlayer connection, and so on to form a Z-shaped double-layer planar spiral structure with a spiral center linear arrangement, where one end of a lower coil layer is vacant and an other end of an upper coil layer is vacant;

Z-shaped double-layer planar spiral structure with a spiral center linear arrangement is electrified to form a characteristic magnetic field structure with non-zero horizontal magnetic vector component; the geometric figure includes a closed geometric figure formed by continuous connection of one end of plane projections of the upper and lower coil layers and crossing of an other end, and an open geometric figure formed by continuous connection of one end of the plane projections of the upper and lower coil layers and non-crossing of the other end; the geometric figure includes polylines, polygons, circular arcs, and a combination of polygons and circular arcs; the interlayer connection includes vertical connection and connection through phase-shifting parts. The phase-shifting parts include resistors, capacitors, inductors, transistors, semiconductor diode phase shifters, ferrite phase shifters, gallium arsenide MMIC phase shifters, and MEMS phase shifters. By controlling the phase-shifting parts, the strength and direction of the magnetic field can be controlled. The upper coil layer vacancy projection area S1 and the lower coil layer vacancy projection area S2 are same and different, where the same and different refer to the same and different number of projected areas.

Preferably, each of the spiral units is a rotating stepped multi-layer planar spiral structure including different coil layers, each of the spiral units of the coil includes multiple layers, each of the layers has a section of conductor, a spacing between adjacent layers is equal, each of the layers forms a plane respectively, spiral centers of all the spiral units are arranged in a linear way, and plane projections of each of the layers of conductor forms a geometric figure, plane projections of a head end of a first lay conductor and that of a tail end of a last layer conductor are not coincident, and a tail end of the first lay conductor is connected with a head end of a next layer conductor of the spiral unit through an interlayer connection; a tail end of the next layer conductor of the spiral unit is connected with a head end of a next layer conductor of the spiral unit through interlayer connection, and so on, until a tail end of a last layer conductor is connected with a head end of a head layer conductor of a next spiral unit through interlayer connection, and finally a rotating stepped multi-layer planar spiral structure of spiral center linear arrangement with a lower part of one end being vacant and an upper part of an other end being vacant is formed; the rotating stepped multi-layer planar spiral structure of spiral center linear arrangement is electrified to form a characteristic magnetic field structure with non-zero horizontal magnetic vector component, and the geometric figure includes a closed geometric figure formed by planar projection of a head end of the first layer conductor and a tail end of a last layer conductor intersecting but not overlapping and plane projections of other layers conductor being continuously connected, and an opening geometry figure formed by plane projections of the head end of the first layer conductor and the tail end of the last layer conductor intersecting and the plane projection of the other layers conductor being continuously connected; the geometric figure includes polygons, circular arcs, and a combination of polygons and circular arcs, the interlayer connection includes vertical connection and connection through phase-shifting parts. The phase-shifting parts include resistors, capacitors, inductors, transistors, semiconductor diode phase shifters, ferrite phase shifters, gallium arsenide MMIC phase shifters, and MEMS phase shifters. By controlling the phase-shifting parts, the strength and direction of the magnetic field can be controlled. An upper vacant projection area S3 and a lower vacant projection area S4 are same and different, where the same and different refer to the same and different number of projected areas.

Preferably, a layer spacing a between adjacent layers of the double-layer planar spiral structure or the multi-layer planar spiral structure and a conductor diameter or thickness d0 preferably satisfy:
when working frequency f≤10 kHz, a=(0.8d0+Δa)±0.1 mm;
when 10 kHz<f≤1 MHz, a=(1.1d0+Δa)±0.05 mm;
when f>1 MHz, a=(0.6d0+Δa)±0.03 mm;
where Δa is a thickness of a composite insulating layer and satisfies 0.05 mm≤Δa≤0.2 mm.

Preferably, a shortest distance R2 of end points of a connecting line or a connecting line fitting line between spiral centers of the first substructures or the third substructures and spiral centers of the second substructures preferably satisfies: R2<(1.618±0.05)R1, and R1 is spiral outer diameter of the first substructures or the third substructures.

Preferably, when spiral centers of the first substructures or the third substructures are not at end points of the spiral center connection line or spiral center connection line fitting line of one or more the second substructures connected with heteromagnetic end connection, a ratio of a length of a spiral center connection line or a spiral center connection line fitting line of same one or more second substructures with heteromagnetic end connection to a length of magnetic circuit connection line of spiral centers of the first substructures and the third substructures preferably satisfies 0.618+/−5%.

Preferably, planar coil structural units are combined and electrified to form a Helbeck permanent magnet array characteristic magnetic field, the Helbeck permanent magnet array characteristic magnetic field includes linear, polygonal, annular and planar Helbeck permanent magnet array characteristic magnetic fields with magnetic surfaces above or below, polygonal, annular, cylindrical, conical, polyhedral and spherical Helbeck permanent magnet array characteristic magnetic fields with magnetic surfaces located on inner surfaces or outer surfaces, and the Helbeck permanent magnet array characteristic magnetic fields with magnetic surfaces located on the inner surfaces include internal uniform magnetic fields. The shape of the spiral center connecting line or the spiral center connecting line fitting line of the planar coil structural unit includes straight line and arc, and all the spiral outer diameter characteristic of the second substructure of the planar coil structural unit include equal spiral outer diameter, spiral outer diameter increases first and then decreases, and spiral outer diameter gradient increases or decreases.

Preferably, planar coil structural units are combined and electrified to form a Helbeck permanent magnet array characteristic magnetic field, the Helbeck permanent magnet array characteristic magnetic field includes polygonal, and annular Helbeck permanent magnet array characteristic magnetic fields with magnetic surfaces above or below; polygonal, annular, cylindrical, conical, polyhedral and spherical Helbeck permanent magnet array characteristic magnetic fields with magnetic surfaces located on inner surfaces or outer surfaces, and the Helbeck permanent magnet array characteristic magnetic fields with magnetic surfaces located on the inner surfaces include internal uniform magnetic fields. The shape of the spiral center connecting line or the spiral center connecting line fitting line of the planar coil structural unit includes straight line and arc, and all the spiral outer diameter characteristic of the second substructure of the planar coil structural unit include equal spiral outer diameter, spiral outer diameter increases first and then decreases, and spiral outer diameter gradient increases or decreases.

The linear Helbeck permanent magnet array characteristic magnetic field with the magnetic surface located above or below can be formed by connecting the same magnetic ends of multiple coil structural units of a substructure spiral center line being linear or arc in a straight line or arc shape and electrifying. The linear Helbeck array planar coil structural unit generates the linear Helbeck permanent magnet array characteristic magnetic field, and the arc Helbeck array planar coil structural unit generates the arc Helbeck permanent magnet array characteristic magnetic field, which can be applied to linear motors and electromagnetic acceleration systems. The planar coil structural units with reduced or increased substructure spiral outer diameter gradient are combined into a linear Helbeck array planar coil combination, and the linear Helbeck permanent magnet array characteristic magnetic field with alternating magnetic flux density is formed after being energized, which can be applied to linear motors and electromagnetic acceleration systems. The acceleration generated by a specific alternating current is greater than the acceleration generated by an alternating current generated by the linear Helbeck permanent magnet array characteristic magnetic field formed by the planar coil structural units with the same spiral outer diameter of the substructure.

The annular Helbeck permanent magnet array characteristic magnetic field with the magnetic surface located above or below is combined into an annular Helbeck array plane coil combination by connecting the same magnetic ends of the plane coil structural units with arc spiral centers, and the axial flux Helbeck permanent magnet array characteristic magnetic field is formed after being electrified, which has the characteristics of better sinusoidal distribution of the magnetic field and can be applied to axial flux motors, magnetic bearings and electromagnetic heating systems.

The polygonal Helbeck permanent magnet array characteristic magnetic field with the magnetic surface above or below is formed by connecting the same magnetic ends of multiple coil structural units with a linear connection line of the substructure spiral center into a polygon and electrifying, and can be applied to axial flux motors, magnetic bearings and electromagnetic heating systems.

multiple linear Helbeck array planar coils are circularly arranged to form a cylinder or a cone, the magnetic pole surface is located on the inner surface or the outer surface of the cylinder, the connecting lines at both ends of the magnetic pole are parallel to the cylinder axis, or the extension lines of the connecting lines at both ends of the magnetic pole intersect with the extension lines of the cone axis at a certain point, and the axial direction or the cone axis of the cylinder is the same as that of a circular magnetic pole, so that the cylindrical or conical Helbeck permanent magnet array characteristic magnetic field can be formed after being energized, and the formed cylindrical or conical coil combination can form a cylindrical or conical acceleration structure by introducing alternating current. When the substructure spiral outer diameter gradient decreases or increases, the acceleration effect is greater than that of cylindrical acceleration structure with all substructures equal. The cylindrical or conical Helbeck permanent magnet array characteristic magnetic field can be applied to linear accelerators and linear motors.

The planar Helbeck permanent magnet array characteristic magnetic field with the magnetic surface above or below can be formed by connecting the same magnetic ends of multiple coil structural units with the substructure spiral center connecting line as a straight line or an arc to form a netted plane and electrifying, and can be applied to planar motor and magnetic levitation systems.

Preferably, bending or folding plane coil structural units are combined and electrified to form a Helbeck permanent magnet array characteristic magnetic field; the Helbeck permanent magnet array characteristic magnetic field with magnetic includes polygonal, polygonal cylindrical, annular, cylindrical, spherical, toroidal and polyhedral Helbeck permanent magnet array characteristic magnetic fields with magnetic surfaces located on inner surfaces or outer surfaces; and the Helbeck permanent magnet array characteristic magnetic fields with magnetic surfaces located on the inner surfaces include internal uniform magnetic fields.

The shape of the spiral center connecting line or the spiral center connecting line fitting line of the planar coil structural unit includes straight line and arc, and all the spiral outer diameter features of the second substructure of the planar coil structural unit include equal spiral outer diameter, spiral outer diameter first increases and then decreases, and spiral outer diameter gradient increases or decreases.

The polygonal Helbeck permanent magnet array characteristic magnetic field with the magnetic surface located on the inner surface or the outer surface is connected into a linear coil combination by the same magnetic ends of multiple coil structural units with linear connection lines at the spiral center of the substructure, the magnetic pole position of the linear coil combination is bent, and the two ends of the bent linear coil combination are connected to form a polygon by adopting a coil expansion structure; the magnetic surface is located inside or outside the ring. When electrified, the polygonal Helbeck permanent magnet array characteristic magnetic field is formed. The polygonal Helbeck permanent magnet array characteristic magnetic field with the magnetic surface located in the ring can form a uniform magnetic field inside the polygon under specific conditions. Multiple polygonal Helbeck array planar coils are combined and axially superposed to form a polygonal cylinder shape, which is the polygonal cylindrical Helbeck permanent magnet array characteristic magnetic field with the magnetic surface located on the inner surface or the outer surface after being electrified, and the polygonal cylindrical permanent magnet array characteristic magnetic field with the magnetic surface located in the ring can form a uniform magnetic field inside the polygonal cylindrical permanent magnet array under specific conditions. The polygonal and polygonal cylindrical Helbeck array planar coil structural unit combination with magnetic surface on the inner surface or the outer surface can be applied to radial flux motor systems, magnetic bearings and electromagnetic heating systems, and the internal uniform magnetic field generated under specific conditions by the polygonal cylindrical Helbeck array planar coil structural unit combination can be applied to nuclear magnetic resonance coil systems.

The annular Helbeck permanent magnet array characteristic magnetic field with the magnetic surface located on the inner surface or the outer surface is connected into a linear coil combination by the same magnetic ends of multiple coil structural units with linear connection lines at the spiral center of the substructure, the linear coil combination is bent, and the two ends of the bent linear coil combination are connected to form an annular by adopting a coil expansion structure; the magnetic surface is located inside or outside the ring. When electrified, the annular Helbeck permanent magnet array characteristic magnetic field is formed. The annular Helbeck permanent magnet array characteristic magnetic field with the magnetic surface located in the ring can form a uniform magnetic field inside the annular under specific conditions. The plurality of annular Helbeck permanent magnet array characteristic magnetic field are axially superposed to form a cylinder shape, which is the cylindrical Helbeck permanent magnet array characteristic magnetic field with the magnetic surface located on the inner surface or the outer surface, and the cylindrical Helbeck permanent magnet array characteristic magnetic field with the magnetic surface located in the ring can form a cylindrical inside uniform magnetic field under specific conditions. The circular and cylindrical Helbeck array planar coil structural unit combination with magnetic surface on the inner surface or the outer surface can be applied to radial flux motor systems, magnetic bearings and electromagnetic heating systems. In particular, the cylindrical Helbeck array plane coil combination with magnetic surface on the inner surface or the outer surface can be used as the hollow cup motor coil, and the internal uniform magnetic field generated by the cylindrical Helbeck array plane coil structure unit combination can be applied to the nuclear magnetic resonance coil system.

The spherical Helbeck permanent magnet array characteristic magnetic field with magnetic surface being located on the inner surface or the outer surface is formed by connecting the same magnetic ends of multiple coil structural units with linear central connection lines of substructures and different outer diameters of each of the substructures into a symmetrical petal-shaped linear coil combination with small two ends and large middle. The magnetic polarities of the two ends of the symmetrical petal-shaped linear coil combination are the same, and multiple symmetrical petal-shaped linear coil combinations are bent into a semicircle, and the same magnetic ends of the two small ends are connected into a sphere, and the magnetic surface is located inside or outside the sphere. When electrified, it is the spherical Helbeck permanent magnet array characteristic magnetic field, and the spherical Helbeck permanent magnet array characteristic magnetic field with magnetic surface in the sphere can form a spherical internal uniform magnetic field under specific conditions. The spherical Helbeck array planar coil structure unit combination with the magnetic surface on the inner surface or the outer surface can be applied to a spherical motor system.

The annular Helbeck permanent magnet array characteristic magnetic field with the magnetic surface located on the inner surface or the outer surface is formed by connecting different magnetic ends of multiple coil structural units of which the connecting line of the spiral center of the substructure is linear or arc-shaped, and the spiral outer diameters of each substructure are different to form a petal-shaped linear coil combination with a small end and a large end. The magnetic polarities of two ends of the petal-shaped linear coil combination are different, multiple petal-shaped linear coil combinations with a small end and a large end are bent into a semicircle, the big end is connected with the big end, and the small end is connected with the small end to form a circular coil structural unit, and multiple circular coil structural units are nested into a circular coil combination. After electrifying, the toroidal coils are combined to form the Helbeck permanent magnet array characteristic magnetic field with the magnetic surface located on the inner surface or the outer surface, and the toroidal Helbeck permanent magnet array characteristic magnetic field with the magnetic surface located inside can form the toroidal shape inside uniform magnetic field under certain conditions.

The polyhedral Helbeck permanent magnet array characteristic magnetic field whose magnetic surface is located on the inner surface or the outer surface can be set in the following ways, namely, the plane coil structure unit across the plane setting and the plane coil structure unit edge setting. The polyhedral Helbeck array planar coil structure unit combination with magnetic surface on the inner surface or the outer surface can be applied to a spherical motor system, and the internal uniform magnetic field generated by the polyhedral Helbeck array planar coil structure unit combination with magnetic surface on the inner surface can be applied to a nuclear magnetic resonance coil system.

The polyhedral Helbeck array coil structure combination with planar coil structure units arranged across a surface is arranged across a polyhedron adjacent surface by planar coil structure unit, specifically, the planar coil structure units across a polyhedron adjacent surface, the spiral centers at both ends are respectively located at the surface center of the polyhedron adjacent surface or have a certain distance from the surface center, and all planar coil structure units in the same surface have the same magnetic polarity. All magnetic poles are located at or symmetrically arranged with the center of the plane, the same magnetic ends of all the planar coil structural units are connected, and the adjacent planes connected with the planar coil structural units have opposite magnetic polarities, and the adjacent planes with the same magnetic polarities are not provided with cross-plane planar coil structural units. After the connected integral polyhedral coil structural units are electrified, the polyhedral Helbeck permanent magnet array characteristic magnetic field with the magnetic surface on the inner surface or the outer surface is formed, and the polyhedral Helbeck permanent magnet array coil combination with the magnetic surface on the inner surface can form a uniform magnetic field inside the polyhedral Helbeck permanent magnet array under certain conditions. The polyhedron is an approximate spherical polyhedron with equal edges, preferably truncated icosahedron, small oblique square truncated icosahedron and twisted dodecahedron. For polyhedrons with unequal areas, it is preferable to adopt coil structural units with unequal outer spiral diameters of all substructure coils. For all the coil structure units with unequal outer diameters of substructure coils, the outer spiral diameter of first substructure is preferably equal to that of second substructure, the outer spiral diameter of second substructure is greater than the inner spiral diameter of second substructure, and the outer spiral diameter of third substructure is preferably equal to the inner spiral diameter of second substructure. The polyhedral coil structure unit combination can also be composed of coil structure units with arc-shaped linear spiral centers.

The polyhedral Helbeck array coil structure combination arranged on the edge of the planar coil structure unit is arranged on the polyhedral edge by planar coil structure unit, specifically, the connecting line of the spiral center of the planar coil structure unit coincides with the polyhedral edge, and the magnetic pole is at a certain distance from the edge vertex. When the distance between the magnetic pole and the edge vertex is zero, the magnetic pole is located at the edge vertex, and all the same magnetic poles in the adjacent area of the same vertex have the same distance from the vertex. The magnetic polarities of the vertices at both ends of the same edge connected by planar coil structural units are opposite. When the magnetic polarities of the vertices at both ends of the same edge are the same, the edge is not provided with planar coil structural units, and all the coil structural units in the adjacent area of the same vertex are connected with the magnetic ends. When the connected integral polyhedral coil structural units are combined with electricity, the polyhedral Helbeck permanent magnet array characteristic magnetic field with the magnetic surface located on the inner surface or the outer surface is formed, and the polyhedral Helbeck array coils with the magnetic surface located on the inner surface are combined to form a uniform magnetic field inside the polyhedral Helbeck permanent magnet array under certain conditions. The polyhedron is an approximate spherical polyhedron with equal edges, preferably truncated icosahedron, small oblique square truncated icosahedron and twisted dodecahedron.

Preferably, two or more planar coil structural units that are not externally connected with the second substructure are connected with the same magnetic end of the spiral center of the first substructure or a certain point of the plane surrounded by the first substructure to form a planar strong magnetic point, the planar strong magnetic point includes the spiral center of the first substructure or a certain point of the plane surrounded by the first substructure. The formed planar strong magnetic point includes a magnetic flux density convergence/divergence vortex strong magnetic point. The planar strong magnetic point coil combination is connected into a ring and a sphere by bending, and the magnetic surface is located inside. After electrifying, the smallest circular Helbeck permanent magnet array internal uniform magnetic field and the smallest spherical Helbeck permanent magnet array internal uniform magnetic field are formed. The planar strong magnetic point can be applied to wireless power transmission, and has the characteristics of high magnetic field intensity, low leakage inductance and high electromagnetic utilization efficiency. The planar strong magnetic point can be applied to axial flux motors and magnetic bearings. Compared with the traditional coil structure, the integral coil combination generates stronger magnetic field intensity, and the coil combination can generate stronger centripetal magnetic induction intensity at the axis center and generate greater torque. The planar coil structural unit that constitutes the planar strong magnetic point includes a planar coil structural unit with a straight or arc spiral center and a planar coil structural unit with gradient increase or gradient decrease of spiral outer diameter of second substructure, and the formed planar strong magnetic point includes a vortex strong magnetic point and a vortex strong magnetic point with converging/diverging magnetic flux density.

The vortex strong magnetic point is formed by the planar coil structural units with arc spiral centers, where the spiral center of the first substructure surrounds a certain point on the plane and is arrange in a central symmetric manner, and the same magnetic ends are connected to form a central symmetric plane coil array combination which is formed aft being electrified, and the distances between the first substructure spiral center and the third substructure spiral center to a certain point on the plane are not equal. The strong magnetic point of the vortex with converging/diverging magnetic flux density is formed by the planar coil structural units with arc spiral center and increasing or decreasing gradient of the spiral outer diameter of the second substructure, where the spiral center of the first substructure are arranged around a certain point in the plane in a central symmetric manner, and the same magnetic ends are connected to form a central symmetric plane coil array combination which is formed aft being electrified, and the distances between the spiral center of the first substructure and the spiral center of the third substructure to a certain point in the plane are not equal.

The planar strong magnetic point is formed by two planar coil structural units which are not externally connected with the second substructure and symmetrically connected with the spiral center of the first substructure as the center. After the two planar coil structural units are bent into a semicircle, the two third substructures are connected to form a ring, and the strong magnetic point is located in the ring. After electrifying, the smallest circular Helbeck permanent magnet array internal uniform magnetic field can be formed, and the magnetic poles are located in the first substructure and the third substructure. The internal uniform magnetic field ring is applied to wireless power transmission, which has the characteristics of high magnetic field intensity, low leakage inductance and high electromagnetic utilization efficiency. A petal-shaped coil combination with small ends and large middle consisting of multiple planar coil structural units which are not externally connected with a second substructure, where the spiral outer diameter of the first substructure is less than or equal to that of the second substructure with the same spiral center, the spiral outer diameter of the second substructure first increases and then decreases, and the spiral outer diameter of the third substructure is less than or equal to spiral inner diameter of the second substructure with the same spiral center, and the planar strong magnetic point is formed by symmetrically connecting the spiral center of the first substructure around the center of a plane. After all the planar coil structural units are bent into a semicircle, the centers of all the third substructures are symmetrically connected to form a sphere, and the strong magnetic points are located in the sphere. After electrifying, the smallest spherical Helbeck permanent magnet array internal uniform magnetic field can be formed, and the magnetic poles are located in the first substructure and the third substructure. The spherical internal uniform magnetic field applied to wireless power transmission has the characteristics of high magnetic field intensity, low leakage inductance and high electromagnetic utilization efficiency. In the practical application process, unnecessary repetitive coils with magnetic pole positions can be eliminated as needed to improve the overall structural uniformity.

Preferably, a planar, polygonal cylindrical, cylindrical, spherical and annular Helbeck array planar coil network combination including multiple Helbeck array planar coil structural units is electrified to form a Helbeck permanent magnet array characteristic magnetic field structure, being applied to construction of magnetic shielding surfaces and magnetic shielding spaces. Where, the planar coil structural units and their combinations include linear and netted planar coil structural units and their combinations, and the netted planar coil structural unit combination also includes planar coil structural unit combinations formed by array or nesting, and the array includes planar coil structural units in point, line and plane arrays. Linear and netted planar coil structural units and their combinations include non-closed-loop and closed-loop coil structural units and their combinations, and the closed-loop coil structural units and their combinations are connected by their own structures or extended structures to form a closed loop. The linear and netted planar coil structural units and their combined shapes include linear (FIG. 30, FIG. 32, FIG. 35 and FIG. 38), folded, circular (FIG. 39), elliptical, circular (FIG. 33), polygonal (FIG. 40 and FIG. 46), planar ring and netted (FIG. 41 and FIG. 42). The linear and netted planar coil structural units and their combinations are electrified to form a linear, folded, circular, elliptical, arc-shaped, polygonal, planar annular and netted planar Helbeck permanent magnet array characteristic magnetic field with the magnetic surface on the upper surface or the lower surface of the coil.

Preferably, a polyhedral Helbeck array planar coil network combination including multiple Helbeck array planar coil structural units is electrified to form a Helbeck permanent magnet array characteristic magnetic field structure, being applied to construction of magnetic shielding surfaces and magnetic shielding spaces. With the development of science and technology and the wide application of electromagnetic technology and permanent magnet materials, researchers pay more and more attention to the non-magnetic space and magnetic shielding space. Conventional non-magnetic space and magnetic shielding space have heavy structures. The disclosure uses electromagnetic coils to form the Helbeck array characteristic magnetic field of the, which can be applied to the construction of magnetic shielding surface and magnetic shielding space, and has the characteristics of low cost, good magnetic shielding effect, light and thin space structure, easy construction and the like. Where the three-dimensional coil structural units and their combinations include coil structural units and their combinations formed by bending or buckling, winding or nesting or stacking, and the three-dimensional coil structural units and their combinations include non-closed-loop and closed-loop coil structural units and their combinations, and the closed-loop three-dimensional coil structural units and their combinations are connected by their own structures or coil expansion structures to form a closed loop. The three-dimensional coil structural unit and their combined shapes include cylinder, polygonal column, frustum, polygonal frustum, cone, polygonal cone, sphere, polyhedron, torus and polygonal torus. The three-dimensional coil structural unit and the combination thereof form the Helbeck permanent magnet array characteristic magnetic field with three-dimensional structural characteristics after being electrified, where the Helbeck permanent magnet array characteristic magnetic field with three-dimensional structural characteristics includes a magnetic field with a magnetic surface on the inner surface or the outer surface or the inner or outer magnetic field, or a magnetic surface on the upper surface or the lower surface of the three-dimensional stacking surface, and the internal magnetic field includes a uniform magnetic field.

The magnetic shielding surface and the magnetic shielding space can be made up of planar, polygonal cylindrical, cylindrical, spherical, annular and polyhedral Helbeck array planar coil netted combination which are composed of multiple Helbeck array planar coil structural unit combination, and they are assembled and customized according to the needs of the construction of the magnetic shielding surface and the magnetic shielding space. The Helbeck array planar coil netted combination is preferably made by flexible printed circuit board technology.

Preferably, the heat dissipation material is preferably a shape memory alloy (SMA) heat pipe structure, and the magnetic conductive material is preferably a magnetic conductive material with relative permeability being ≥100 μ0 or effective relative permeability of magnetorheological magnetic conductive material being ≥100 μ0 when external electric field intensity is 2-5 kV/mm.

Preferably, the Helbeck array plane coil structural unit combination is applied to magnetic resonance, electromagnetic accelerator, particle accelerator, detector, magnetic levitation, motor and generator, electromagnetic sensor, magnetic energy storage, wireless power transmission, electromagnetic shielding, magnetic therapy device, electromagnetic detection, electromagnetic molding, electromagnetic ultrasonic transducer, magnetic separation and electromagnetic stirring.

Preferably, both the Helbeck array planar coil structural unit and the coil combination composed of the Helbeck array planar coil structural unit are connected in series, parallel or series-parallel hybrid connection. The coil structure combination can be used in combination with the coil structure combination consisting of the Helbeck array planar coil structure units with opposite magnetic poles, and can also be used in combination with the Helbeck permanent magnet array.

The coil polyhedron combination with strong magnetic characteristics inside is paired with permanent magnet sphere with strong magnetic surface outside, or the coil polyhedron combination with strong magnetic characteristics outside is paired with permanent magnet sphere with strong magnetic surface of Helbeck permanent magnet array inside, or the coil polyhedron combination with strong magnetic characteristics outside is paired with the coil polyhedron combination with strong magnetic characteristics inside, which can be applied to manufacturing spherical motors.

Preferably, the coil structure units and combination thereof are made by printed circuit board method or planar coil splicing method; the printed circuit board method preferably adopts HDI process, with line width/line spacing ≤50 μm, blind hole diameter ≤100 μm and interlayer alignment error ≤5 μm; the planar coil splicing method is preferably laser welding or nano-silver paste conductive adhesive welding.

Compared with the prior art, the disclosure has the following advantages and technical effects:
firstly, the disclosure realizes the coiling of the magnetic field structure of the Helbeck permanent magnet array, and gets rid of the application limitation of permanent magnet materials to the Helbeck array magnetic field;
secondly, the disclosure adopts the planar spiral coil arrangement or lamination mode to significantly flatten and miniaturize the Helbeck array coil structure;
thirdly, the planar spiral coil with the spiral centers arranged in a linear manner adopted in the structure of the disclosure is more conducive to the adjustment of magnetic field uniformity than the traditional concentrated winding coil;
fourthly, the coil-type Helbeck array structure of the disclosure is a flexible structure, which is more conducive to practical application compared with the rigid structure of Helbeck permanent magnet array;
fifth, the magnetic field structure of the coiled Helbeck permanent magnet array of the disclosure inherits the characteristics of strong magnetic field intensity and high sinusoidal degree of the magnetic field structure of Helbeck permanent magnet array;
sixth, the structure of the disclosure realizes the single-sided circulation of the magnetic circuit, which significantly improves the electromagnetic utilization ratio and reduces the cost of magnetic leakage control compared with the traditional coil double-sided magnetic circuit.

### BRIEF DESCRIPTION OF THE DRAWINGS

In order to explain the embodiments of the disclosure or the technical scheme in the prior art more clearly, the drawings needed in the embodiments will be briefly introduced below. Obviously, the drawings in the following description are only some embodiments of the disclosure, and for ordinary skilled in the field, other drawings can be obtained according to these drawings without creative efforts:

FIG. 1A is a schematic structural diagram of a single-layer concentric planar spiral coil;

FIG. 1B is a schematic structural diagram of a double-layer concentric planar spiral coil;

FIG. 1C is a schematic structural diagram of a planar spiral coil with single-layer spiral centers arranged in a straight line;

FIG. 1D is a schematic structural diagram of a planar spiral coil with double-layer spiral centers arranged in a straight line;

FIG. 2E is a schematic structural diagram of a planar spiral coil with the spiral centers arranged in a straight line with the gradient of the outer diameter of the double-layer spiral increasing or decreasing;

FIG. 2F is a schematic structural diagram of a planar spiral coil with double-layer spiral with equal outer diameters and straight-line arrangement of spiral centers;

FIG. 2G is a schematic structural diagram of a planar spiral coil with the spiral centers arranged in a straight line with the gradient of the outer diameter of the double-layer spiral increasing or decreasing;

FIG. 3 is a schematic structural diagram of planar spiral coils with arc-shaped single-layer spiral centers;

FIG. 4 is a schematic structural diagram of planar spiral coils with arc-shaped double-layer spiral centers;

FIG. 5A is a schematic structural diagram of a planar spiral coil with spiral centers arranged in an arc-shape with the gradient of double-layer spiral outer diameter increasing or decreasing;

FIG. 5B is a schematic structural diagram of a planar spiral coil with double-layer spiral equal outer diameters and spiral centers arranged in an arc-shape;

FIG. 6A is an illustration of a concentric planar spiral coil with a magnetic circuit vertically downward;

FIG. 6B is an illustration of a concentric planar spiral coil with a magnetic circuit vertically upward;

FIG. 7A is an illustration of planar spiral coils with non-zero rightward magnetic potential component, equal spiral outer diameters and straight arrangement of spiral centers;

FIG. 7B is an illustration of planar spiral coils with non-zero leftward magnetic potential component, the gradient of the spiral outer diameter decreasing or increasing and straight arrangement of spiral centers;

FIG. 8A is an illustration of planar spiral coils with non-zero rightward magnetic potential component, equal spiral outer diameters and arc-shape arrangement of spiral centers;

FIG. 8B is an illustration of planar spiral coils with non-zero leftward magnetic potential component, the gradient of the spiral outer diameter decreasing or increasing and arc-shape arrangement of spiral centers;

FIGS. 9A-9C are schematic diagrams of the extended structure of the Helbeck array planar coil structural unit, in which FIG. 9A is the structural diagram of first substructure, FIG. 9B is the structural diagram of third substructure, and FIG. 9C is the structural diagram of second substructure;

FIGS. 10A-10E are schematic diagrams of the extended structure of another Helbeck array planar coil structure unit, in which FIG. 10A is a schematic structural diagram of a combination of a first substructure and a second substructure, FIG. 10B is a schematic structural diagram of a combination of a third substructure and a second substructure, FIG. 10C is a schematic structural diagram of a combination of a third substructure and three second substructures, FIG. 10D is a schematic structural diagram of a combination of a first substructure and two second substructures, and FIG. 10E is a schematic structural diagram of a combination of a third substructure and two second substructures;

FIGS. 11A-11D are schematic diagrams of yet extended structure of the Helbeck array planar coil structure unit, in which FIG. 11A is a schematic diagram of a combination of first substructure, third substructure and second substructure, and FIG. 11B is a schematic diagram of a combination of first substructure, third substructure and two second substructures, and the two second substructures are inserted and expanded in a same magnetic end arrangement; FIG. 11C is a schematic structural diagram of a combination of first substructure, third substructure and three second substructure; and FIG. 11D is a schematic structural diagram of a combination of first substructure, third substructure and two second substructures, and the two second substructures are inserted and expanded in a different magnetic end arrangement;

FIG. 12 is a linear planar coil structural unit with the equal spiral outer diameter of the second substructure;

FIG. 13 is an arc-shaped planar coil structural unit with the equal spiral outer diameter of the second substructure;

FIG. 14 is a linear planar coil structural unit with decreasing spiral outer diameter gradient of the second substructure;

FIG. 15 is an arc-shaped planar coil structural unit with decreasing spiral outer diameter gradient of the second substructure;

FIG. 16 is a linear planar coil structural unit externally connected with a second substructure;

FIG. 17 is an arc planar coil structure unit externally connected with two second substructures;

FIG. 18 is a linear planar coil structural unit externally connected with five second substructures;

FIG. 19 is an arc planar coil structure unit externally connected with six second substructures;

FIG. 20 is a linear Helbeck array planar coil structural combination;

FIG. 21 is a linear alternating magnetic flux density Helbeck array planar coil structural combination;

FIG. 22 is an annular Helbeck array planar coil structural combination;

FIG. 23 is a netted Helbeck array planar coil structural combination;

FIG. 24 is a strong magnetic point Helbeck array planar coil structural combination;

FIG. 25 is an annular minimum internal magnetic field Helbeck array planar coil structural combination;

FIG. 26 is a planar alternating polarity Helbeck array planar coil structural combination;

FIG. 27 is a netted Helbeck array planar coil structural combination;

FIG. 28 is a truncated icosahedral Helbeck array planar coil structural combination for edge coils;

FIG. 29 is a truncated icosahedral Helbeck array planar coil structural combination for cross-plane coils;

FIG. 30 is a coil structure unit consisting of a first substructure and a third substructure with two second substructure arranged in a straight line with the spiral centers with equal outer diameters;

FIG. 31 is a coil structure unit consisting of four first substructures and a third substructure with six second substructures arranged in a straight line with the spiral centers with equal outer diameters;

FIG. 32 is a coil structure unit consisting of a first substructure and a third substructure with two second substructure arranged in a straight line with the spiral centers of spiral outer diameter gradient increasing or decreasing;

FIG. 33 is a coil structure unit consisting of a first substructure and a third substructure with two second substructures arranged in an arc-shape with the spiral centers with equal outer diameters;

FIG. 34 is a coil structure unit consisting of a first substructure and a third substructure with five second substructure arranged in an arc-shape with the spiral centers of spiral outer diameter gradient increasing or decreasing;

FIG. 35 is a coil structure unit consisting of a first substructure and a third substructure with four second substructures arranged in a straight line with the spiral centers with equal spiral outer diameters;

FIG. 36 is a coil structure unit consisting of a first substructure and a third substructure with twelve second substructures of equal spiral outer diameters;

FIG. 37 is a coil structure unit composed of six first substructures and two third substructures, and twelve second substructures with spiral center in a straight line arrangement with spiral outer diameter gradient increasing or decreasing.

FIG. 38 is a schematic diagram of the linear Helbeck array coil structural unit combination formed by self-connecting extension of four structures of FIG. 30;

FIG. 39A is a three-layer linear closed-loop (circular) Helbeck array coil structure unit combination formed by self-connecting extension of the three structures of FIG. 33;

FIG. 39B is a schematic diagram of the magnetic direction of the coil combination of FIG. 39A;

FIG. 40A is a four-layer linear closed-loop Helbeck array coil structure unit combination formed by stacking six coil structure units of FIG. 1B arranged in a regular hexagon and six coil structure units of FIG. 4 arranged in a regular hexagon with different projection points staggered by 30 degrees;

FIG. 40B is a schematic diagram of the magnetic direction of the coil combination of FIG. 40A;

FIG. 41 is a mesh three-ring coil structure unit combination consisting of one coil structure unit, six coil expansion structure first substructures, ten coil expansion structure second substructures and five coil expansion structure third substructures in FIG. 34, which are expanded in a central symmetric manner;

FIG. 42 is a schematic diagram of the magnetic direction of the netted Helbeck array coil structure unit combination formed by arranging or laminating multiple first substructures, second substructures and third substructures according to the coil position requirements;

FIG. 43A is a double-layer coil structure unit consisting of a single-layer hexagonal first substructure coil, five double-layer second substructures and a single-layer third substructure in a stacked manner;

FIG. 43B is a schematic diagram of the magnetic direction of the coil combination of FIG. 43A;

FIG. 44 is a schematic diagram of the partial structure in FIG. 43;

FIG. 45A is a large view of the coil structure combination formed by taking the coil structure unit as the array object and taking the regular dodecagon center as the array center;

FIG. 45B is coil structure unit of FIG. 45A;

FIG. 46A is a single-layer Helbeck array planar coil structure unit composed of six coil structures in FIG. 1A and six coil structures in FIG. 3,

FIG. 46B is a schematic diagram of the magnetic direction of the coil combination;

FIG. 47 is a planar spiral coil arrangement structure in which a single-layer concentric planar spiral coil and a single-layer spiral center arranged in a line;

FIG. 48 is a planar spiral coil arrangement structure in which double-layer concentric planar spiral coils with opposite spiral directions are linearly arranged with the double-layer spiral center;

FIG. 49 is a double-layer planar spiral structure in which a single-layer concentric planar spiral coil and a planar spiral coil of single-layer spiral center in a linear arrangement are stacked;

FIG. 50 is a double-layer planar spiral structure in which a single-layer concentric planar spiral coil and a planar spiral coil of a double-layer planar spiral coil including an upper coil layer and a lower coil layer in a linear arrangement are stacked;

FIG. 51 is a four-layer structure in which a double-layer concentric plane spiral coil and a plane spiral coil with the double-layer spiral center in a linear arrangement are stacked;

FIG. 52 is a four-layer structure in which a double-layer concentric planar spiral coil and a plane spiral coil with two single-layer planar spiral centers in a linear arrangement are stacked;

FIG. 53 is a four-layer structure in which a double-layer and two single-layer concentric planar spiral coils are stacked with planar spiral coils with double-layer spiral centers including an upper ring layer and a lower ring layer in a linear arrangement;

FIG. 54 is a three-layer structure in which a single-layer concentric planar spiral coil and a planar spiral coil of a double-layer spiral center including an upper coil layer and a lower coil layer in a linear arrangement are stacked, showing a material filling layer in the middle of the second substructure coil;

FIG. 55 is a four-layer structure in which a single-layer concentric planar spiral coil and a planar spiral coil of a double-layer spiral center including an upper coil layer and a lower coil layer in a linear arrangement are stacked, showing the upper and lower material filling layers of the second substructure coil;

FIG. 56 is a Z-shaped double-layer planar spiral structure monomer formed by combining an upper ring layer and a lower ring layer in each ring;

FIG. 57 is a top view of a rotating stepped three-layer planar spiral structure monomer, which is composed of different layers in each ring;

FIG. 58 is a top view of a rotating stepped six-layer planar spiral structure monomer, which is composed of different layers in each ring;

FIG. 59 is a monomer diagram of a rotating stepped six-layer planar spiral structure with interlayer connecting wires;

FIG. 60 is a diagram of a rotating stepped six-layer planar spiral structure with spiral centers in a linear arrangement;

FIG. 61 is a structural electromagnetic vector simulation diagram in FIG. 5B;

FIG. 62A is a schematic structural diagram of the annular stereo coil structural unit combination in Embodiment 35;

FIG. 62B shows the unwound coil structure of FIG. 62A;

FIG. 63 is an expanded view of the soccer ball-shaped Helbeck array coil structural unit combination in Embodiment 37.

where, 1001 coil outer diameter end; 1002 coil inner diameter end; 1003 coil spiral center; 1004 coil spiral center connecting line; 1005 upper coil layer; 1006 lower coil layer; 1007 vertical downward magnetic circuit; 1008 vertical upward magnetic circuit; 1009 horizontal magnetic vector component direction arrow; 1010 spiral inner diameter; 1011 spiral outer diameter; 1012 spiral center fitting line; 1 first substructure; 2 second substructure; 3 the third substructure; 4 material filling layer; 3001 first layer; 3002 second layer; 3003 third layer; 3004 fourth layer; 3005 fifth layer; 3006 sixth layer;
101 a first substructure plane spiral coil with a magnetic circuit vertically downward of spiral outer diameter being equal to that of the third substructure;
102 a first substructure plane spiral coil with a magnetic circuit vertically upward of spiral outer diameter being larger than that of the third substructure;
103 a first substructure plane spiral coil with a magnetic circuit vertically downward of a spiral outer diameter larger than that of the third substructure;
201 a linear second substructure plane spiral coil with the same spiral outer diameter and the horizontal component of the magnetic direction to the right;
202 an arc-shaped second substructure plane spiral coil with the same spiral outer diameter and the horizontal component of the magnetic direction to the left;
203 a linear second substructure plane spiral coil with the horizontal component of the magnetic direction to the right and the spiral outer diameter gradient decreasing;
204, an arc-shaped second substructure plane spiral coil with the horizontal component of the magnetic direction to the right and the spiral outer diameter gradient decreasing;
205 a linear second substructure plane spiral coil with the same spiral outer diameter and the horizontal component of the magnetic direction to the left;
206 a linear second substructure plane spiral coil with the horizontal component of the magnetic direction to the left and the spiral outer diameter gradient decreasing;
207 an arc-shaped second substructure plane spiral coil with the same spiral outer diameter and the horizontal component of the magnetic direction to the right;
208 an arc-shaped second substructure plane spiral coil with the horizontal component of the magnetic direction to the left and the spiral outer diameter gradient decreasing;
209 a linear second substructure plane spiral coil with the horizontal component of the magnetic direction to the left and the spiral outer diameter gradient increasing;
301 a third substructure plane spiral coil with a magnetic circuit vertically upward of spiral outer diameter being equal to that of the first substructure;
302 a third substructure plane spiral coil with a magnetic circuit vertically downward of spiral outer diameter being smaller than that of the first substructure;
303 a third substructure plane spiral coil with a magnetic circuit vertically upward of spiral outer diameter being smaller than that of the first substructure;
401 the second substructure of the linear coil expansion structure with equal spiral outer diameters;
402 the second substructure of arc coil expansion structure with equal spiral outer diameters;
403 the second substructure of the linear coil expansion structure with decreasing spiral outer diameter gradient;
404 the second substructure of the arc coil expansion structure with decreasing spiral outer diameter gradient; and
500 the Helbeck array magnetic ring unit formed by the netted arc planar coil structural unit combination.

### DETAILED DESCRIPTION OF THE EMBODIMENTS

In the following, the technical scheme in the embodiment of the disclosure will be described clearly and completely in combination with the attached drawings in the embodiment of the disclosure. Obviously, the described embodiment is only a part of the embodiment of the disclosure, but not all of the embodiments. Based on the embodiments in the disclosure, all other embodiments obtained by ordinary skilled in the field without creative efforts belong to the scope of protection of the disclosure.

In order to make the above objects, features and advantages of the disclosure more obvious and easy to understand, the disclosure will be further described in detail with the attached drawings and specific embodiments.

It should be understood that in the description of the disclosure, the magnetic field intensity of each substructure plane spiral coil and the number of external coil expansion structures of the Helbeck array plane coil structure unit are not specified, only for the convenience of describing the simplified description of the technical scheme of the disclosure. In the attached drawings, the vertical magnetic field direction adopts the inner circle with x to indicate the vertical downward magnetic field, the inner circle with ∘ to indicate the vertical upward magnetic field, the arrow direction of the second substructure indicates the horizontal component direction of the magnetic field, and the thickness of the two ends of the arrow indicates size of the spiral outer diameter of the second substructure, just to clearly describe the attached structure. Therefore, it should not be construed as a limitation of the disclosure. This embodiment is only for illustrating the technical scheme, and does not limit the protection scope of the disclosure.

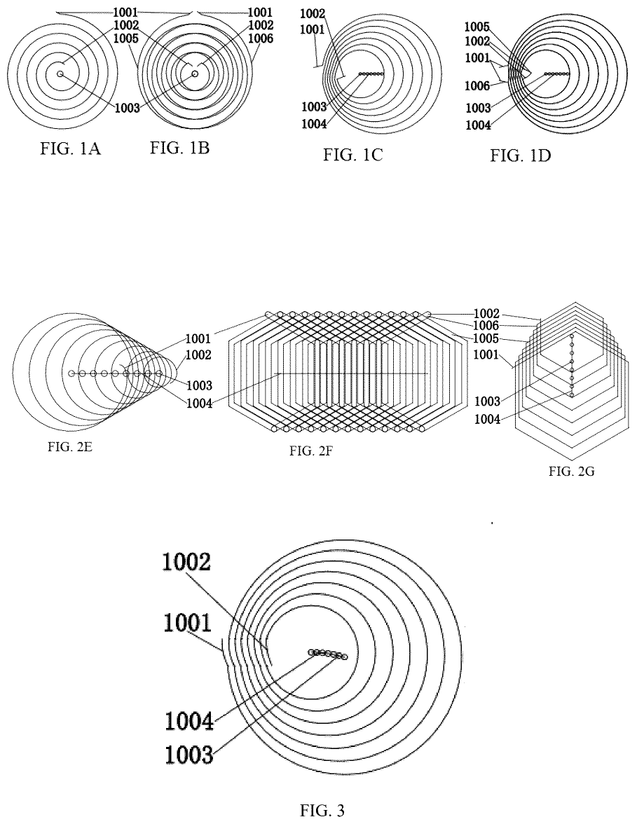

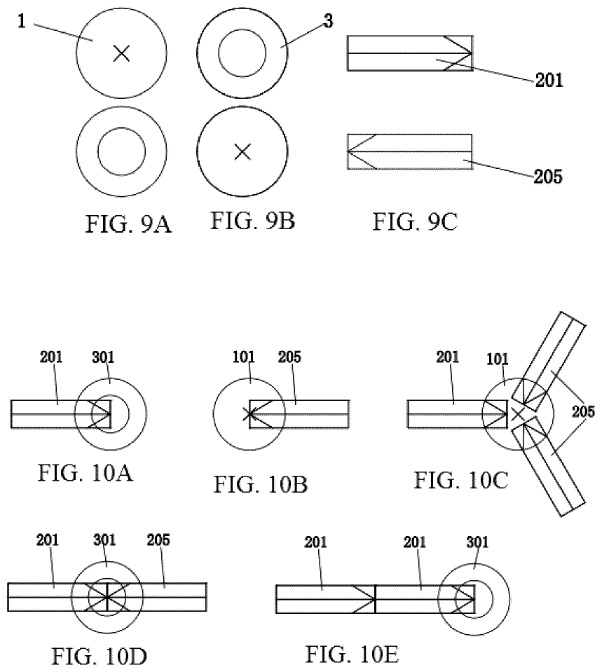

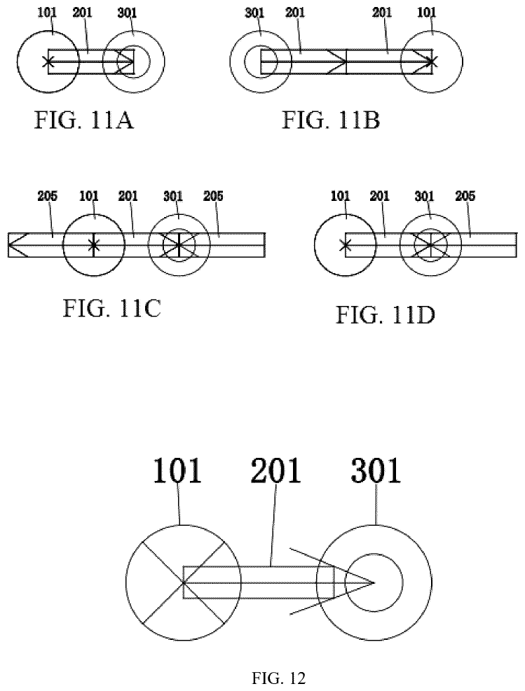

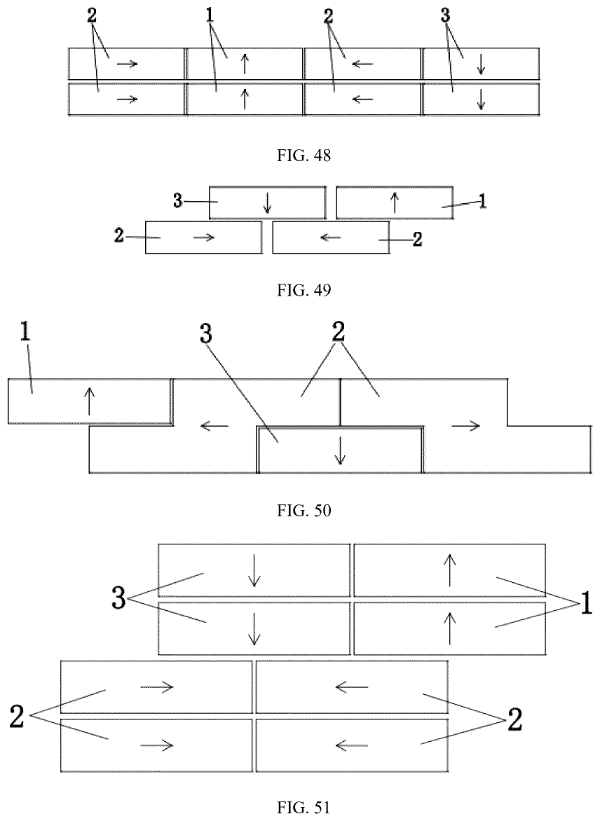

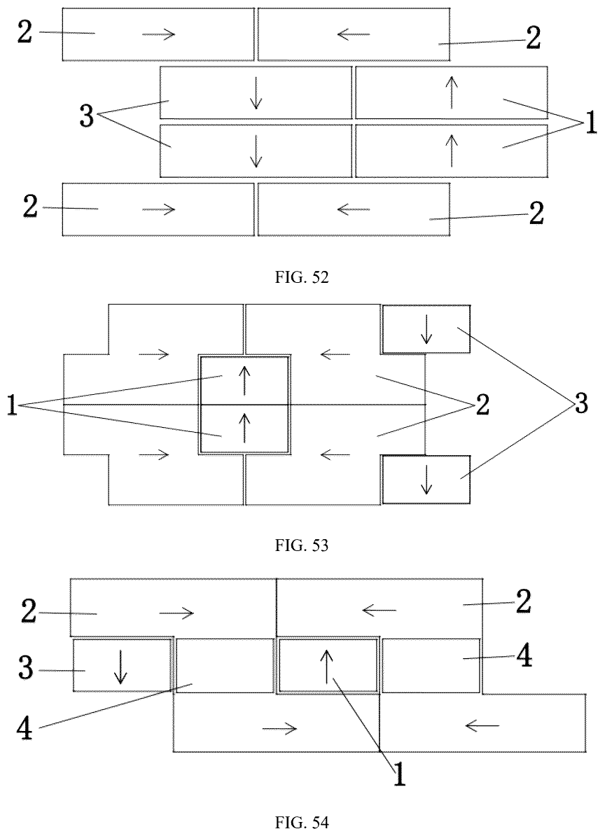

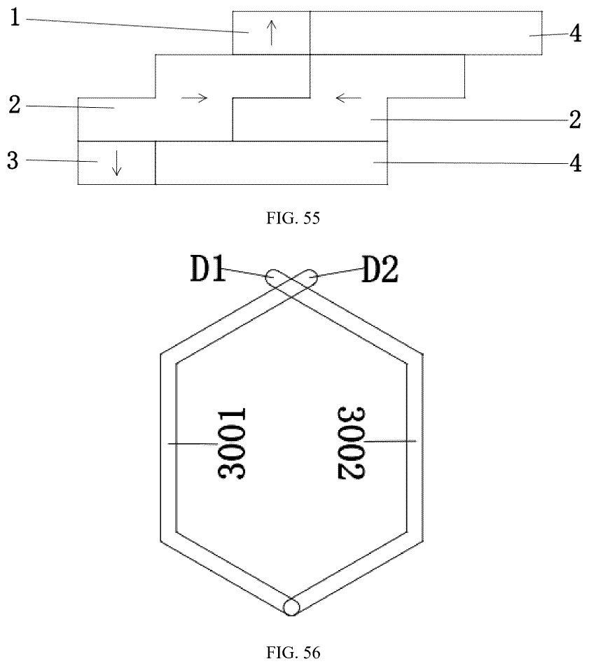

As shown in FIG. 1-FIG. 60, the disclosure provides a Helbeck array plane coil structural unit, which includes:
three types of substructures: first substructures, second substructures and third substructures;
where, the first substructures and the third substructures are concentric planar spiral coils with opposite magnetic circuits in a vertical direction after being electrified, and the second substructures are plane spiral coils of a spiral center linear arrangement with a horizontal component in a magnetic direction after being electrified; spiral center linear arrangement modes of the second substructures includes a spiral center connecting line arrangement or a spiral center connecting line fitting line being a straight line or an arc arrangement; all spiral outer diameters in the second substructures are same or different; coil layerings of the first substructures, the second substructures and the third substructures include a single-layer planar spiral structure, a double-layer planar spiral structure and a multi-layer planar spiral structure;
coil position arrangement modes of the first substructures, the second substructures and the third substructures include:
spiral centers of the first substructures and the third substructures are located at both ends between coil spiral center connecting lines of the second substructures, and two or more the second substructures are centered on concentric plane spiral centers of the first substructures or the third substructures, and homomagnetic ends are symmetrical arrangement or centrally symmetric arrangement; or, spiral centers of the first substructures and the third substructures are respectively located at two end of a horizontal magnetic circuit formed by one or more the second substructures, and two or more substructures between two ends of a horizontal magnetic circuit formed by multiple the second substructures are heteromagnetic end arrangement;
modes of coil arrangement or lamination into a plane include:
firstly, the first substructures, the second substructures and the third substructures are single-layer planar spiral structures or double-layer planar spiral structures to arrange in a plane;
secondly, end points of connecting lines or fitting lines between spiral centers of the first substructures or the third substructures with double-layer planar spiral structures or multi-layer planar spiral structures and spiral centers of the second substructures are different, and projection points are stacked into a plane;
thirdly, end points of connecting lines or fitting lines between spiral centers of the first substructures or the third substructures with single-layer planar spiral structures and double-layer planar spiral structures, multi-layer planar spiral structures and spiral centers of the second substructures are different, and projection points are stacked into a plane;
fourthly, end points of connecting lines or fitting lines between spiral centers of the first substructures or the third substructures with single-layer planar spiral structures and double-layer planar spiral structures, multi-layer planar spiral structures and spiral centers of the second substructures are same, and projection points are stacked into a plane;
fifthly, end points of connecting lines or fitting lines between spiral centers of the first substructures or the third substructures with single-layer planar spiral structures and double-layer planar spiral structures, multi-layer planar spiral structures and spiral centers of the second substructures are same, and projection points laminate and combine material filling layers to form a plane;
composition of coil structural unit and magnetic field characteristics include:
plane spiral coils of one or more of the first substructures, the second substructures and the third substructures are stacked into a plane or more than two-layer thin-layer structure according to coil position arrangement modes, coil arrangement or lamination into a plane mode, all substructures are connected in series, parallel or series-parallel hybrid mode to form the Helbeck array coil structure units, and a Helbeck permanent magnet array characteristic magnetic field is formed after being electrified, where spiral centers of the first substructures and the third substructures are coil structure unit north and south poles respectively, and north and south poles at two ends of the second substructures and the first substructures and the third substructures form a magnetic circuit connection, and magnetic polarity of unconnected ends of the second substructures is opposite to that of connected ends; spiral central connecting line shapes of the planar coil structural units include a straight line, an arc and a net shape;
coil structural unit connection expansion modes include:
according to the coil position arrangement modes, the coil arrangement or lamination into a plane mode, connection expansion is performed through self-structure or connection expansion is performed through coil expansion structure;
a coil structure unit combination includes linear and netted planar coil structure unit combination formed by self-structure connection expansion or coil expansion structure connection expansion, a planar coil structure unit combination formed by coil structure unit array or nesting, and a three-dimensional coil structure unit combination formed by coil structure unit bending or folding or winding or nesting or stacking;
where magnetic field characteristics of the coil structure unit combination include:
firstly, in-plane line and surface type characteristic magnetic field: linear, zigzag, circular, toroidal, arc-shaped, elliptical, polygonal, and netted plane Helbeck permanent magnet array characteristic magnetic field with magnetic surface located on upper or lower surface of coils;
secondly, three-dimensional structure characteristic magnetic field: Helbeck permanent magnet array characteristic magnetic field with magnetic surface located on inner surface or outer surface or inside or outside coils, and Helbeck permanent magnet array characteristic magnetic field with magnetic surface located on an upper surface or lower surface of a coil stacking surface; Helbeck permanent magnet array characteristic magnetic field with magnetic surface located inside coils includes uniform magnetic field;
insulating materials, or heat dissipation materials, or heat dissipation pipelines, or magnetic conductive materials are stacked or filled above or below or between layers the coil structural units and combinations thereof, so as to improve corresponding insulation performance, heat dissipation performance, magnetic conductivity performance and coil structural regularity performance of the coil structural units;
the coil structural units and combinations thereof are made by printed circuit board method or planar coil splicing method.

Specifically, as shown in FIGS. 1 to 8 and FIGS. 47 to 60, the coil layering of the first substructure and the third substructure includes a single-layer planar spiral structure, such as FIG. 1A, a double-layer planar spiral structure, such as FIG. 1B, and a multi-layer concentric planar spiral structure. The double-layer planar spiral structure is formed by connecting coils with opposite spiral directions in series or coils with the same direction in parallel, such as FIG. 1B. The multi-layer concentric planar spiral structure includes multiple single-layer planar spiral structures or multiple double-layer planar spiral structures or a series, parallel or series-parallel combination of concentric planar spiral structures combining multiple single-layer planar spiral structures and a double-layer planar spiral structure. The interlayer gaps in the double-layer planar spiral structure or the multi-layer planar spiral structure are filled with insulating materials, heat dissipation materials, heat dissipation pipelines or magnetic conduction materials.

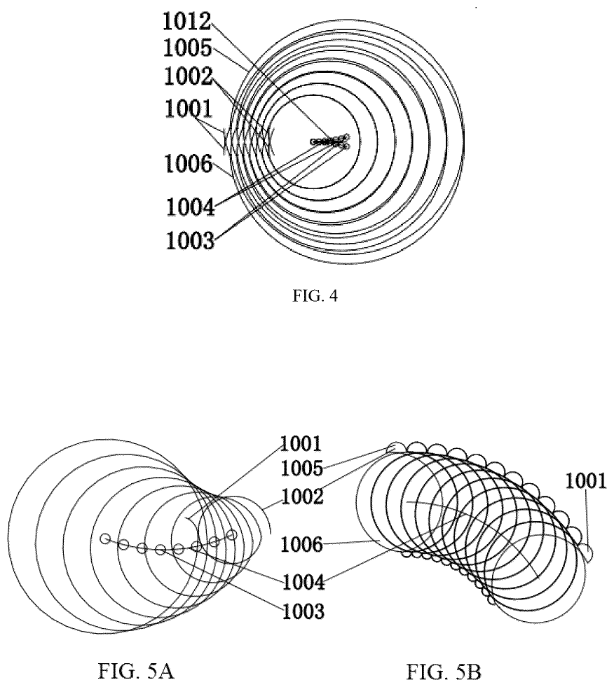

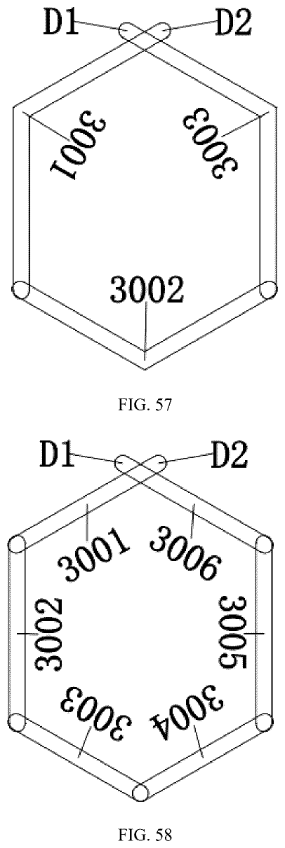

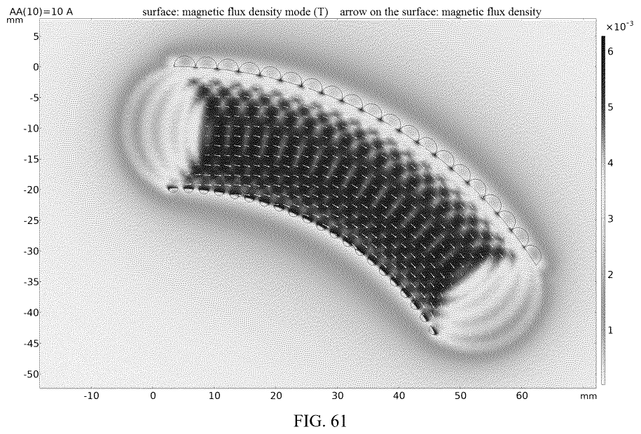

The second substructure is a planar spiral coil in which the spiral centers are in line arrangement as shown in FIG. 1C, FIG. 1D, FIG. 2, FIG. 3, FIG. 4, FIG. 5 and FIG. 61, including spiral center connecting lines as shown in FIG. 1C, FIG. 1D, FIG. 2 and FIG. 3, the spiral center connecting line fitting lines as shown in FIG. 4, straight lines as shown in FIG. 1C, FIG. 1D and FIG. 2, and arc arrangement as shown in FIG. 3 and FIG. 5. The coil layering of the second substructure includes a single-layer planar spiral structure as shown in FIG. 1A and FIG. 3, and a double-layer planar spiral structure as shown in FIG. 1D, FIG. 2 and FIG. 5. The single-layer planar spiral structure is planar spiral coils with spiral centers arranged linearly as shown in FIG. 1C and FIG. 3. The double-layer planar spiral structure is formed by connecting coils with opposite spiral directions in series as shown in FIG. 1 D and FIG. 4 or connecting coils in the same direction in parallel. Or a Z-shaped double-layer planar spiral structure formed by the combination of an upper coil layer and a lower coil layer for each spiral unit, as shown in FIG. 2 and FIG. 5. The multi-layer planar spiral structure includes multiple single-layer planar spiral structures or multiple double-layer planar spiral structures in series, parallel or series-parallel combination, or a rotating stepped multi-layer planar spiral structure with different coil layers for each spiral unit, as shown in FIG. 57 to FIG. 60. The interlayer gap in the double-layer planar spiral structure or the multi-layer planar spiral structure is filled with insulating material, heat dissipation material, heat dissipation pipeline or magnetic conductive material as shown in FIG. 54. The features of spiral outer diameter of the second substructure include the same spiral outer diameter as shown in FIG. 2F and FIG. 5B, and the increase or decrease of spiral outer diameter gradient as shown in FIG. 1C and FIG. 1D, and FIG. 2E, FIG. 2G, FIG. 3 and FIG. 5A.

Each of the spiral units has a Z-shaped double-layer planar spiral structure formed by combining an upper coil layer and a lower coil layer, the upper coil layer and the lower coil layer are respectively planar, spiral centers of all the spiral units are arranged in a linear way, planar projection of the upper coil layer and the lower coil layer of each of the spiral units surrounds a geometric figure, and plane projections of a head end of the upper coil lay and a tail end of the lower coil lay are not coincident; a tail end of an upper coil lay of the spiral unit is connected with a head end of a low coil layer of the spiral unit through an interlayer, and a tail end of a lower coil lay of the spiral unit is connected with a head end of an upper coil layer of a next spiral unit through an interlayer connection, and so on to form a Z-shaped double-layer planar spiral structure with a spiral center linear arrangement, where one end of a lower coil layer is vacant and an other end of an upper coil layer is vacant. Z-shaped double-layer planar spiral structure with a spiral center linear arrangement is electrified to form a characteristic magnetic field structure with non-zero horizontal magnetic vector component; the geometric figure includes a closed geometric figure formed by continuous connection of one end of plane projections of the upper and lower coil layers and crossing of an other end, and an open geometric figure formed by continuous connection of one end of the plane projections of the upper and lower coil layers and non-crossing of the other end; the geometric figure includes polygons, circular arcs, and a combination of polygons and circular arcs; the interlayer connection includes vertical connection and connection through phase-shifting parts. The phase-shifting parts include resistors, capacitors, inductors, transistors, semiconductor diode phase shifters, ferrite phase shifters, gallium arsenide MMIC phase shifters, and MEMS phase shifters. By controlling the phase-shifting parts, the strength and direction of the magnetic field can be controlled. The upper coil layer vacancy projection area S1 and the lower coil layer vacancy projection area S2 preferably satisfy: 0.618±0.05≤S1/S2≤1.618±0.05. FIG. 56 is a monomer diagram of the Z-shaped double-layer planar spiral structure. The monomers D2 are arranged and expanded in sequence by interlayer connection D1, and finally the Z-shaped double-layer planar spiral structure is formed, as shown in FIG. 2F and FIG. 2G, FIG. 5B. The plan projection of FIG. 56 is hexagonal, and the first layer 3001 is the intersection of the upper coil layer head end D2 and the second layer 3002, that is the lower coil layer tail end D1. The upper coil layer vacancy projection area S1 and the lower coil layer vacancy projection area S2 include same kind as shown in FIG. 2F and different kind as shown in FIG. 2G. The upper and lower coil layers are closely connected, or filled with insulating material, heat dissipation material, heat dissipation pipeline or magnetic conductive material.

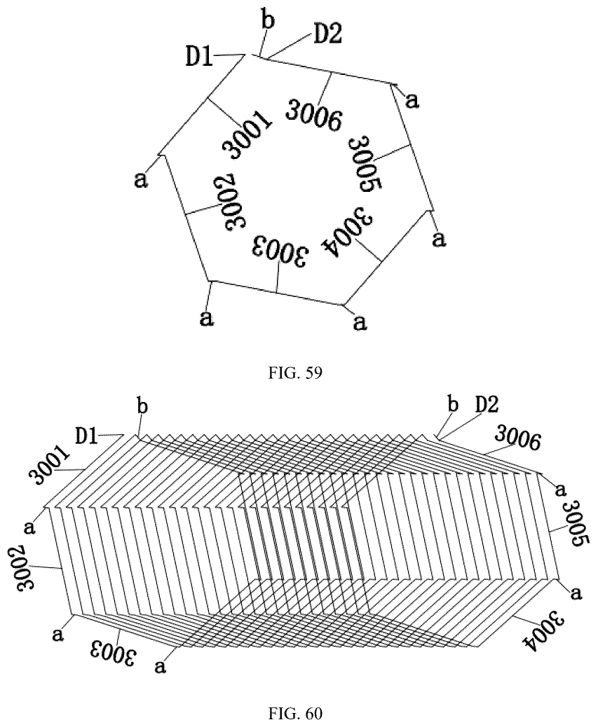

Each of the spiral units is a rotating stepped multi-layer planar spiral structure including different coil layers, each of the spiral units of the coil includes multiple layers, each of the layers has a section of conductor, a spacing between adjacent layers is equal, each of the layers forms a plane respectively, spiral centers of all the spiral units are arranged in a linear way, and plane projections of each of the layers of conductor forms a geometric figure, plane projections of a head end of a first lay conductor and that of a tail end of a last layer conductor are not coincident, and a tail end of the first lay conductor is connected with a head end of a next layer conductor of the spiral unit through an interlayer connection; a tail end of the next layer conductor of the spiral unit is connected with a head end of a next layer conductor of the spiral unit through interlayer connection, and so on, until a tail end of a last layer conductor is connected with a head end of a head layer conductor of a next spiral unit through interlayer connection, and finally a rotating stepped multi-layer planar spiral structure of spiral center linear arrangement with a lower part of one end being vacant and an upper part of an other end being vacant is formed; the rotating stepped multi-layer planar spiral structure of spiral center linear arrangement is electrified to form a characteristic magnetic field structure with non-zero horizontal magnetic vector component, and the geometric figure includes a closed geometric figure formed by planar projection of a head end of the first layer conductor and a tail end of a last layer conductor intersecting but not overlapping and plane projections of other layers conductor being continuously connected, and an opening geometry figure formed by plane projections of the head end of the first layer conductor and the tail end of the last layer conductor intersecting and the plane projection of the other layers conductor being continuously connected; the geometric figure includes polygons, circular arcs, and a combination of polygons and circular arcs, the interlayer connection includes vertical connection and connection through phase-shifting parts. The phase-shifting parts include resistors, capacitors, inductors, transistors, semiconductor diode phase shifters, ferrite phase shifters, gallium arsenide MMIC phase shifters, and MEMS phase shifters. By controlling the phase-shifting parts, the strength and direction of the magnetic field can be controlled. The upper vacant projection area S3 and the lower vacant projection area S4 preferably satisfy: 0.618±0.05≤S3/S4≤1.618±0.05. FIG. 57 is a top view of the monomer of the rotating stepped three-layer planar spiral structure. D2 among the monomer top views is connected with D1 through interlayer connecting wires, which are laid flat and expanded in turn to finally form a rotating stepped three-layer planar spiral structure. FIG. 58 is a top view of the monomer of the rotating stepped six-layer planar spiral structure, and D2 among the monomer top views is connected with D1 through interlayer connecting wires, which are laid flat and expanded in turn to finally form a rotating stepped six-layer planar spiral structure. FIG. 59 is a monomer of rotating stepped six-layer planar spiral structure, which shows six layers and connecting wires a and b among layers in the spiral, where a is the connecting wire between adjacent layers and b is the interlayer connecting wire between adjacent coils. FIG. 58 shows that the plane projection is hexagonal, and the first layer 3001 is the intersection of the upper layer head end D1 and the sixth layer 3006, that is, the last layer tail end D2. FIG. 59 shows that the plane projection is hexagonal, and the first layer 3001, that is, the upper coil layer head end D1, and the sixth layer 3006, that is, the last layer tail end D2, do not cross. The rotating stepped multi-layer planar spiral structure is preferably printed by PCB, FPC and 3D printing technology. The coil layers are closely connected, or filled with insulating material, heat dissipation material, heat dissipation pipeline or magnetic conductive material, and finally a regular planar spiral structure is formed. where the heat dissipation material is preferably a shape memory alloy (SMA) heat pipe structure, and the magnetic conductive material is preferably a magnetic conductive material with a relative permeability of >100 μ0 or when the external electric field intensity is 2-5 kV/mm, the effective relative permeability of magnetorheological materials is ≥100 μ0.

The planar spiral coils with spiral centers in a line arrangement, a layer spacing a between adjacent layers of the double-layer planar spiral structure or the multi-layer planar spiral structure and a conductor diameter or thickness d0 preferably satisfy:
when working frequency f≤10 kHz, a=(0.8d0+Δa)±0.1 mm;
when 10 kHz<f≤1 MHz, a=(1.1d0+Δa)±0.05 mm;
when f>1 MHz, a=(0.6d0+A a)±0.03 mm;
where Δa is a thickness of a composite insulating layer and satisfies 0.05 mm≤Δa≤0.2 mm, as shown in FIG. 59 and FIG. 60, the connecting wire a is connected between adjacent layers.

### Embodiment 1

As shown in FIG. 12, it is a linear Helbeck array planar coil structural unit with the same spiral outer diameter of the second substructure. The Helbeck array planar coil structural unit is composed of a first substructure 101 planar spiral coil with a magnetic circuit vertically downward with the same spiral outer diameter as the third substructure 301, and a linear second substructure 201 planar spiral coil with the same spiral outer diameter and a magnetic horizontal component to the right. The spiral center of the planar spiral coil of the first substructure 101 coincides with the spiral center of the left end of the planar spiral coil of the second substructure 201, and the spiral center of the right end of the planar spiral coil of the second substructure 201 is connected with the planar spiral coil of the third substructure 301 with a vertical upward magnetic circuit. All the substructures are connected in series, parallel or series-parallel hybrid connection to form a planar coil structure unit, and the magnetic field structure of the Helbeck permanent magnet array is formed after being electrified.

### Embodiment 2

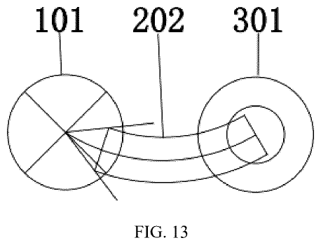

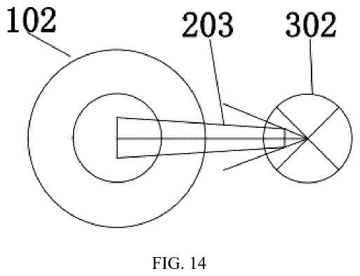

As shown in FIG. 13, it is an arc-shaped Helbeck array planar coil structural unit with the same spiral outer diameter of the second substructure. The difference between the Helbeck array planar coil structural unit and Embodiment 1 is that the second substructure 202 is an arc-shaped planar coil structural unit with the same spiral outer diameter.

### Embodiment 3

As shown in FIG. 14, it is a linear Helbeck array planar coil structural unit with decreasing spiral outer diameter gradient of the second substructure. The difference between the Helbeck array planar coil structural unit and Embodiment 1 is that the second substructure 203 is a linear planar coil structural unit with decreasing spiral outer diameter gradient, the first substructure 102 is a planar coil structural unit with vertical upward magnetic circuit, and the third substructure 302 is a planar coil structural unit with vertical downward magnetic circuit, and the spiral outer diameter of the first substructure 102 is larger than that of the third substructure 302.

### Embodiment 4

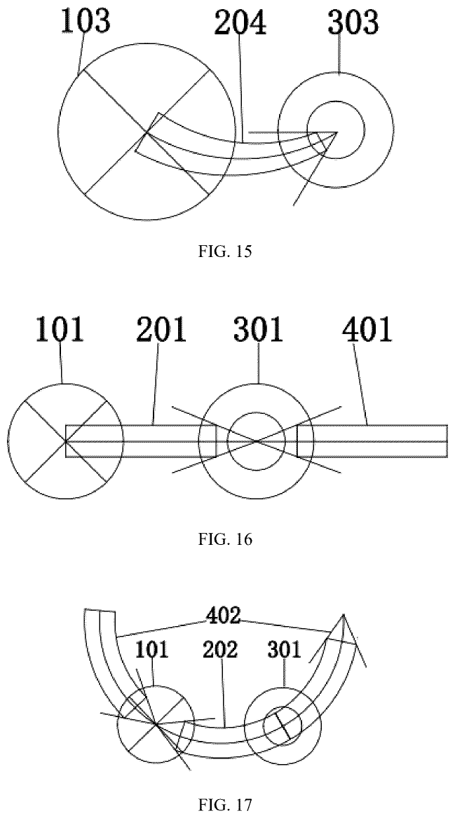

As shown in FIG. 15, it is an arc-shaped Helbeck array planar coil structural unit with decreasing spiral outer diameter gradient of the second substructure. The difference between the Helbeck array planar coil structural unit and Embodiment 1 is that the second substructure 204 is an arc-shaped planar coil structural unit with decreasing spiral outer diameter gradient, the first substructure 103 is a planar coil structural unit with vertical downward magnetic circuit, and the third substructure 303 is a planar coil structural unit with vertical upward magnetic circuit, and the spiral outer diameter of the first substructure 103 is larger than that of the third substructure 303.

### Embodiment 5

As shown in FIG. 16, it is a linear Helbeck array planar coil structure unit externally connected with a second substructure of a coil expansion structure. The difference between the Helbeck array planar coil structure unit and Embodiment 1 is that the spiral center of the planar spiral coil of the third substructure 301 is externally connected with a planar spiral coil of the second substructure 401 with a coil expansion structure, and the second substructure 201 is connected with the same magnetic end of the second substructure 401 of the coil expansion structure.

### Embodiment 6

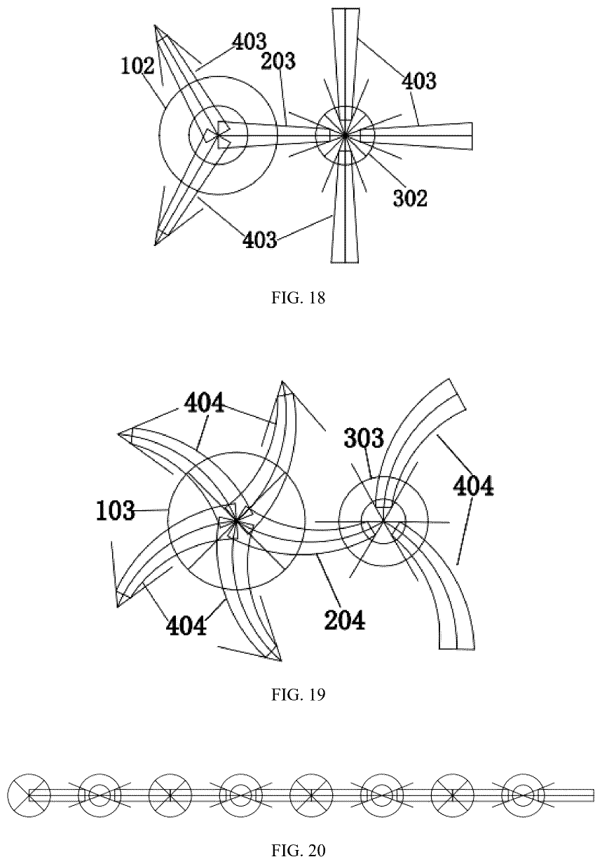

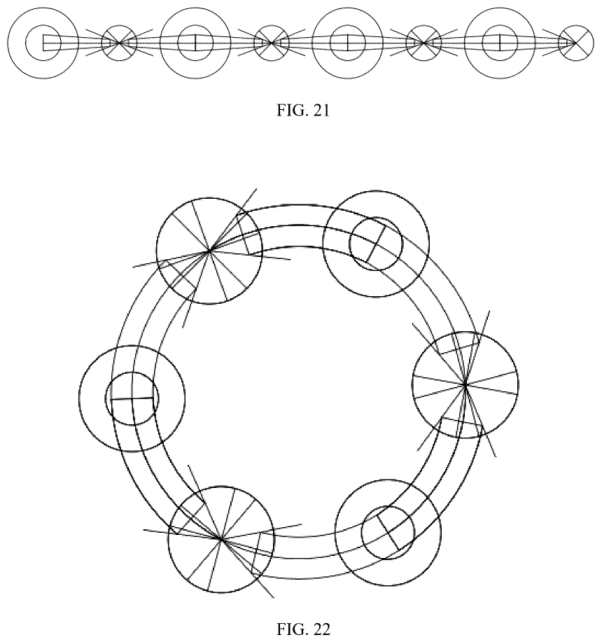

As shown in FIG. 17, it is an arc-shaped Helbeck array planar coil structure unit externally connected with two coil expansion structures. The difference between the Helbeck array planar coil structure unit and Embodiment 2 is that the spiral centers of the planar spiral coils of the first substructure 101 and the third substructure 301 are respectively externally connected with a planar spiral coil of the second substructure 402 of the coil expansion structure, and the second substructure 202 is connected with the second substructure 402 of two coil expansion structures at the same magnetic end.

### Embodiment 7

As shown in FIG. 18, it is a linear Helbeck array planar coil structural unit externally connected with a second substructure of five coil expansion structures. The difference between the Helbeck array planar coil structural unit and Embodiment 3 is that the spiral center of the planar spiral coil of the first substructure 102 is externally connected with planar spiral coils of the second substructure 403 of two coil expansion structure. The second substructure 403 with two coil expansion structures is symmetrically arranged with the planar spiral coils of the second substructure 203 and connected with the same magnetic end; the spiral center of the planar spiral coils of the third substructure 302 is externally connected with the planar spiral coils of the second substructure 403 of three coil expansion structures; and the planar spiral coils of the second substructure 403 of three coil expansion structures are symmetrically arranged with the planar spiral coils of the second substructure 203 and connected with the same magnetic end.

### Embodiment 8

As shown in FIG. 19, it is an arc-shaped Helbeck array planar coil structural unit externally connected with a second substructure of six coil expansion structures. The difference between the Helbeck array planar coil structural unit and Embodiment 4 is that the spiral center of the planar spiral coil of the first substructure 103 is externally connected with planar spiral coils of the second substructure 404 with four coil expansion structures. The second substructure 404 with four coil expansion structures is symmetrically arranged with the planar spiral coils of the second substructure 204 and connected with the same magnetic end. The spiral center of the planar spiral coils of the third substructure 303 is externally connected with the planar spiral coils of the second substructure 404 with two coil expansion structures; and the second substructure 404 with two coil expansion structures and the planar spiral coils of the second substructure 204 are symmetrically arranged and connected with the magnetic end. In this embodiment, the second substructure 204 can also be replaced by the second substructure 201, the second substructure 202 and the second substructure 203, and the first substructure 103 and the third substructure 303 can also be replaced by coils with equal spiral outer diameters, and the spiral outer diameters of all substructures can be equal.

### Embodiment 9

As shown in FIG. 20, the linear Helbeck array planar coil structure combination is formed by connecting four linear Helbeck array planar coil structural units generated in Embodiment 5 and connecting with the magnetic end in a straight line, and the linear Helbeck permanent magnet array characteristic magnetic field can be formed after being electrified, which can be applied to linear motors and electromagnetic acceleration systems.

### Embodiment 10

As shown in FIG. 21, the linear alternating magnetic flux density Helbeck array planar coil structure combination is formed by connecting the same magnetic ends of the seven linear Helbeck array planar coil structure unit with decreasing spiral outer diameter gradient of the second substructure 203 generated in the Embodiment 3 in a straight line, which can form the linear alternating magnetic flux density Helbeck permanent magnet array characteristic magnetic field after being electrified, and can be applied to linear motors and electromagnetic acceleration systems. Compared with the electromagnetic acceleration structure formed in Embodiment 9, the region with strong magnetic flux density of this structure can generate greater acceleration. In the specific implementation process, unnecessary repetitive coils with magnetic pole positions can be eliminated according to the implementation needs, so as to improve the overall uniformity of coils.

### Embodiment 11

As shown in FIG. 22, the annular Helbeck array planar coil structure combination is formed by six arc Helbeck array planar coil structural units with the same spiral outer diameter as the second substructure 202 produced in Embodiment 2, which are connected with the same magnetic ends to form a ring. When energized, the axial flux Helbeck permanent magnet array characteristic magnetic field can be formed, which has higher sinusoidal distribution characteristics and can be applied to axial flux motors, electromagnetic bearings and electromagnetic heating systems. In the specific implementation process, unnecessary repetitive coils with magnetic pole positions can be eliminated according to the implementation needs, so as to improve the overall uniformity of coils.

### Embodiment 12

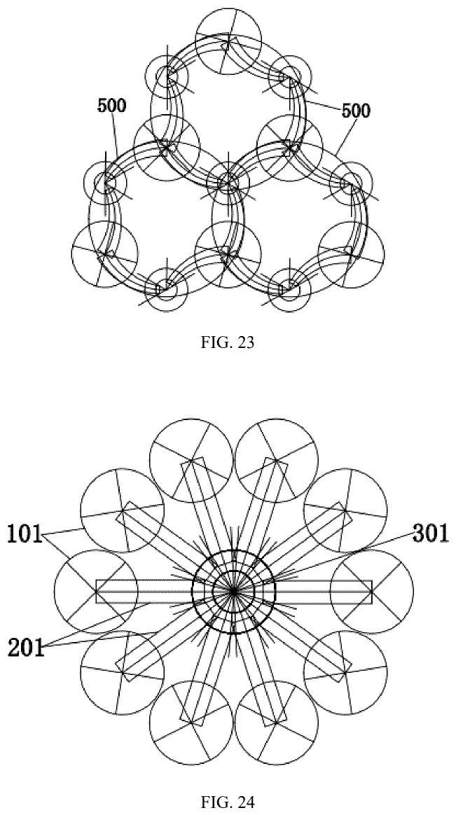

As shown in FIG. 23, the netted Helbeck array planar coil structure combination is formed by fifteen arc Helbeck array planar coil structure units with decreasing spiral outer diameter gradient of the second substructure 204 produced in Embodiment 4 and connected with the same magnetic end to form a netted Helbeck array planar coil structure combination, which can form three Helbeck array magnetic ring units 500 with alternating magnetic flux density. The planar Helbeck permanent magnet array characteristic magnetic field can be formed after the combination of netted Helbeck array planar coil structures is electrified, which can be applied to magnetic levitation and planar motor systems. The second substructure 201 of the coil combination can also be replaced by the second substructure 202, the second substructure 203 and the second substructure 204, and the first substructure 101 and the third substructure 301 can also be replaced by coils with equal spiral outer diameters. In the specific implementation process, unnecessary repetitive coils with magnetic pole positions can be eliminated according to the implementation needs, so as to improve the overall uniformity of coils.

### Embodiment 13

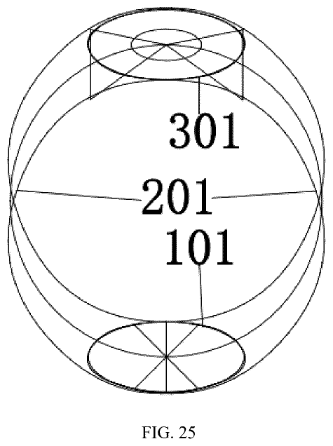

As shown in FIG. 24, the strong magnetic point Helbeck array plane coil structure combination is formed by ten linear Helbeck array plane coil structure units with the same spiral outer diameter of the second substructure 201 produced in Embodiment 1, taking that spiral center of the third substructure 301 as the center, the same magnetic ends being symmetrically arrange to form a strong magnetic point coil structure. The coil combination second substructure 201 can also be replaced by the second substructure 202, the second substructure 203 and the second substructure 204, and the spiral outer diameters of all the substructures can be equal, and the first substructure 101 and the third substructure 301 can also be replaced by coils with unequal spiral outer diameters. The strong magnetic point Helbeck array planar coil structure combination can be applied to electromagnetic heating and wireless power transmission system. In the specific implementation process, unnecessary repetitive coils with magnetic pole positions can be eliminated according to the implementation needs, so as to improve the overall uniformity of coils.

### Embodiment 14

Embodiment 14 is a minimum internal magnetic field Helbeck array planar coil structure combination. It is formed by bending the linear Helbeck array planar coil structure unit generated in Embodiment 5, which is externally connected with the second substructure of a coil expansion structure, into a ring. The inner ring first substructure 101 is connected with the unconnected end of the coil expansion structure second substructure 401, and the spiral centers of the first substructure 101 and the third substructure 301 are opposite, so that the minimum internal magnetic field can be formed after being energized.

As shown in FIG. 25, the minimum internal magnetic field can also be formed by connecting two linear Helbeck array planar coil structural units with the same spiral outer diameter of the second substructure produced in Embodiment 1 with the same magnetic ends and bending them into a ring, and the spiral centers of the first substructure 101 and the third substructure 301 in the ring are opposite. In the figure, the third substructure 301 is turned over by bending through 180 degrees, the original upward magnetic circuit turns into a downward magnetic circuit, which is just connected with the downward magnetic circuit of the first substructure 101. The downward magnetic circuit of the first substructure 101 is guided by the curved upward magnetic circuit of the second substructure 201 at both sides, and the magnetic circuit of the first substructure 101 is transmitted upward to the third substructure 301 along the side wall of the second substructure 201, thus forming an internal magnetic circuit cycle. The minimum internal magnetic field Helbeck array planar coil structure combination forms that the magnetic pole position is located at the spiral centers of the first substructure 101 and the third substructure 301 after being energized.

The minimum internal magnetic field Helbeck array planar coil structure combination generated by this embodiment can form a characteristic internal magnetic field external shielding structure after being electrified, which can be applied to wireless power transmission and has the characteristics of high transmission efficiency and low leakage inductance.

In addition, it should be noted that the minimum internal magnetic field Helbeck array planar coil structure combination generated by the two methods in this embodiment has the characteristics of internal magnetic shielding when the magnetic pole faces are located outside the ring.

### Embodiment 15

Embodiment 15 is a radial flux Helbeck array planar coil structure combination. It is formed by a linear Helbeck array planar coil structure combination produced in Embodiment 9 and bent into a circular ring, which is connected end to end to form a radial flux Helbeck array planar coil structure combination ring, and the magnetic pole faces are located inside or outside the ring, which can be applied to radial flux motors.

### Embodiment 16

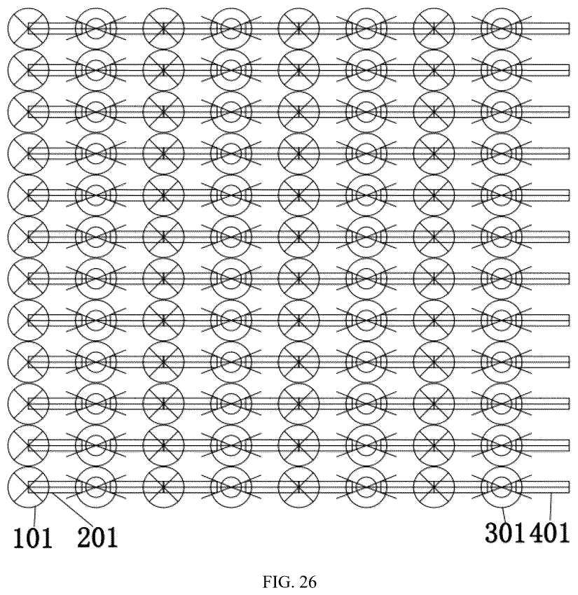

As shown in FIG. 26, it is a planar alternating polarity Helbeck array planar coil structure combination. It is formed by twelve linear Helbeck array planar coil structure combination generated in Embodiment 9 to form a square structure coil combination. When energized, it forms a planar alternating polarity Helbeck permanent magnet array characteristic magnetic field, which can be applied to a planar acceleration system. In this embodiment, the second substructure 201 can also be replaced by the second substructure 202, the second substructure 203 and the second substructure 204, and the first substructure 101 and the third substructure 301 can also be replaced by coils with unequal spiral outer diameters.

### Embodiment 17

Embodiment 17 is a cylindrical Helbeck array planar coil structure combination. It is formed by the planar alternating polarity Helbeck array planar coil structure combination generated in Embodiment 16 being bent and rolled into a cylinder along all the first substructure 101 directions, which can form a coil combination structure with the magnetic surface on the inner surface or the outer surface and the magnetic circuit direction being axial, and can be applied to a cylindrical acceleration system. In this embodiment, by adjusting the spiral outer diameter of each first substructure, the planar alternating polarity Helbeck array planar coil structure combination can be bent and rolled into a conical shape along all the first substructures 101.

The planar alternating polarity Helbeck array planar coil structure combination generated in Embodiment 16 is bent and rolled into a cylinder along the direction of the first substructure 101 and the second substructure 401 of the coil expansion structure, which can form a coil combination structure with the magnetic surface on the inner surface or the outer surface and the magnetic path direction radial, and can be applied to electromagnetic bearing systems. In this embodiment, the coil combination structure with magnetic surface on the inner surface and radial magnetic path direction can also form an internal uniform magnetic field under specific setting conditions, which can be applied to magnetic resonance imaging system.

### Embodiment 18

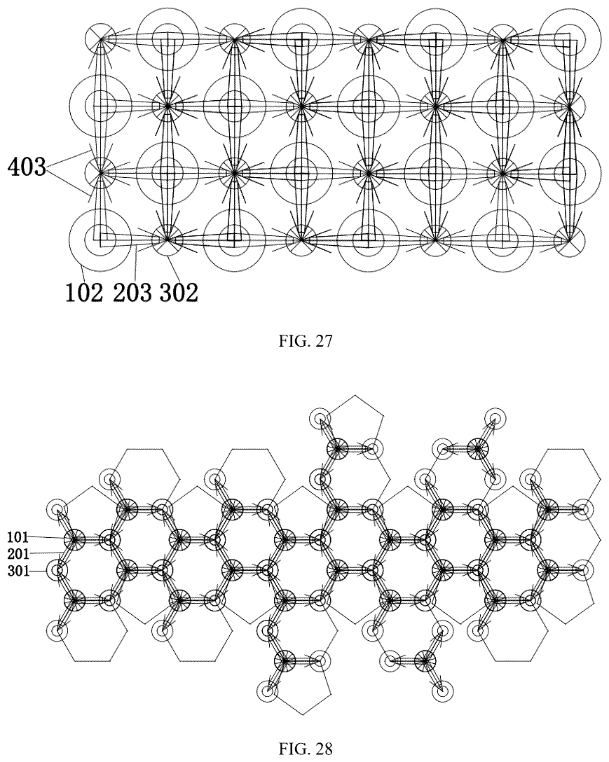

As shown in FIG. 27, it is a netted Helbeck array planar coil structure combination. It is formed by the four linear Helbeck array planar coil structure combination generated by Embodiments 10 is arranged in four rows in parallel in opposite directions, the second substructure 403 and the second substructure 203 with twenty-four coil expansion structures being adopted between rows, and are connected with the same magnetic end to form a netted Helbeck array planar coil structure combination. After being electrified, the planar alternating magnetic flux density Helbeck permanent magnet array characteristic magnetic field is formed, which can be applied to planar motor and magnetic levitation systems. In this embodiment, the second substructure 203 can also be replaced by the second substructure 201, the second substructure 202 and the second substructure 204, and the first substructure 102 and the third substructure 302 can also be replaced by coils with equal spiral outer diameters, and the spiral outer diameters of all substructures can also be equal. The netted Helbeck array planar coil structure combination generated in this embodiment can also be bent and wound into a cylindrical shape, and the magnetic pole surface is located on the inner surface or the outer surface, which can be applied to the electromagnetic bearing system. The cylindrical coil structure combination with magnetic pole faces on the inner surface can form an internal uniform magnetic field under certain conditions, which can be applied to magnetic resonance imaging system.

### Embodiment 19

Embodiment 19 is a truncated icosahedron Helbeck array planar coil structure combination. The truncated icosahedron is 32-sided polyhedron, including 20 regular hexagons and 12 regular pentagons, as shown in FIG. 28, which is a polyhedron development diagram after connecting the Helbeck array planar coil structural units. The truncated icosahedral Helbeck array planar coil structure combination is formed by 72 linear Helbeck array planar coil structure units with the same spiral outer diameter of the second substructure 201 in Embodiment 1. The first substructure 101 and the third substructure 301 are located at the vertices of polyhedron, and the magnetic polarities of the vertices at both ends of the same edge connected by the planar coil structure units are opposite. When the magnetic polarities of the vertices at both ends of the same edge are the same, the edge is not provided with a planar coil structure unit, and the polyhedral Helbeck permanent magnet array characteristic magnetic field with the magnetic pole face inside or outside is formed after the truncated icosahedral Helbeck array planar coil structure combination is electrified, and the polyhedral Helbeck permanent magnet array characteristic magnetic field with the magnetic pole face inside can form a uniform magnetic field inside the polyhedral Helbeck permanent magnet array under certain conditions. In the concrete implementation process, unnecessary repeated coils are eliminated. The polyhedral Helbeck array planar coil structure unit combination with magnetic surface on the inner surface or the outer surface generated in this embodiment can be applied to spherical motor systems, and the internal uniform magnetic field generated by the polyhedral Helbeck array planar coil structure unit combination with magnetic surface on the inner surface can be applied to nuclear magnetic resonance coil systems. In this embodiment, the second substructure 201 can also be replaced by the second substructure 202, the second substructure 203 and the second substructure 204, and the first substructure 101 and the third substructure 301 can also be replaced by coils with unequal spiral outer diameters. Although regular pentagons and regular hexagons are not seamlessly connected in the expanded drawing, all regular pentagons and regular hexagons will be seamlessly connected after the expanded drawing is connected into a truncated icosahedron according to the adjacent edges of regular polygons.

### Embodiment 20

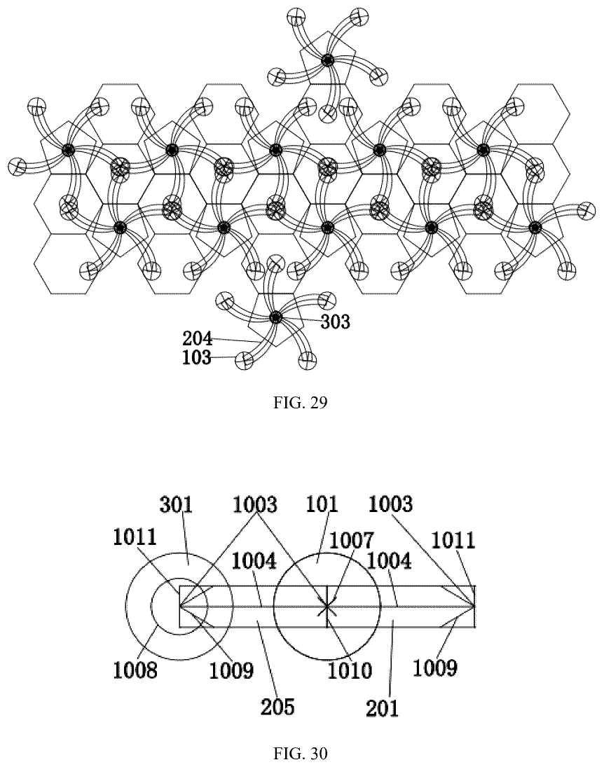

Embodiment 20 is a truncated icosahedral Helbeck array plane coil structure combination, and the truncated icosahedron is 32-sided polyhedron, including 20 regular hexagons and 12 regular pentagons, as shown in FIG. 29, which is a polyhedron development diagram after connecting the Helbeck array plane coil structural units. The truncated icosahedral Helbeck array planar coil structure combination is formed by connecting the same magnetic end of 60 arc planar coil structure unit combination with decreasing spiral outer diameter gradient, which are composed of the second substructure 204 of Embodiment 4. The spiral centers of the first substructure 103 of all planar coil structure units are located in the surface center of a regular hexagon, and the spiral centers of the third substructure 303 of all planar coil structure units are located in the surface center of a regular Pentagon. The adjacent surfaces connected by the planar coil structural units have opposite magnetic polarities, and the adjacent surfaces with the same magnetic polarities are not provided with cross-plane planar coil structural units. After electrifying, the connected truncated icosahedral Helbeck array planar coil structures are combined to form a polyhedral Helbeck permanent magnet array characteristic magnetic field with magnetic poles surface on the inner surface or the outer surface. The polyhedral Helbeck permanent magnet array characteristic magnetic field with magnetic pole surface inside can form uniform magnetic field inside polyhedral Helbeck permanent magnet array under certain conditions. The polyhedral Helbeck array planar coil structure unit combination with magnetic surface on the inner surface or the outer surface generated in this embodiment can be applied to spherical motor systems, and the internal uniform magnetic field generated by the polyhedral Helbeck array planar coil structure unit combination with magnetic surface on the inner surface can be applied to nuclear magnetic resonance coil systems. In this embodiment, the second substructure 204 can also be replaced by the second substructure 201, the second substructure 202 and the second substructure 203, and the first substructure 103 and the third substructure 303 can also be replaced by coils with equal spiral outer diameters. Although the regular pentagons and the regular hexagons are not seamlessly connected, and the spiral centers of the first substructures 103 at the center of the regular hexagons are not coincident, all the regular pentagons and the regular hexagons will be seamlessly connected. However, after the expanded figure is connected into a truncated icosahedron according to the adjacent edges of a regular polygon, all regular pentagons and regular hexagons will be seamlessly connected, and the spiral centers of all the first substructures 103 will be located in the center of the regular hexagon.

### Embodiment 21

As shown in FIG. 30, it is the simplest Helbeck array coil structure unit composed of four coils. A first substructure 101 and a third substructure 301 are a coil structure unit composed of two second substructures 2 with two spiral center connecting line 1004 with equal spiral outer diameters of 1010=1011. The spiral centers 1003 of the first substructure 101 and the third substructure 301 are located at the end point of the spiral center connecting line 1004 of the second substructure 205. All spiral centers 1003 of the first substructure 101, the second substructure 2 and the third substructure 301 are located in the same straight line. The coil structure unit can be self-connected and expanded through the unconnected ends of the first substructure 101 and the second substructure 205, where the second substructure 2 includes the second substructure 205 and the second substructure 201.

### Embodiment 22

As shown in FIG. 32, a first substructure 101, a third substructure 301 and a second substructure 2 with two spiral centers linearly arranged 1004 with increasing or decreasing (1011>1010) spiral outer diameter gradient form a coil structure unit. The spiral centers 1003 of the first substructure 101 and the third substructure 301 are located on the extension line of the spiral center connecting line 1004 of the second substructure 2. All spiral centers 1003 of the first substructure 101, the second substructure 2 and the third substructure 301 are connected in a straight line, where the two of the second substructures 2 can be linear second substructure plane spiral coils 206 with the horizontal component of the magnetic direction decreasing with the spiral outer diameter gradient to the left and linear second substructure plane spiral coils 203 with the horizontal component of the magnetic direction decreasing with the spiral outer diameter gradient to the right.

### Embodiment 23

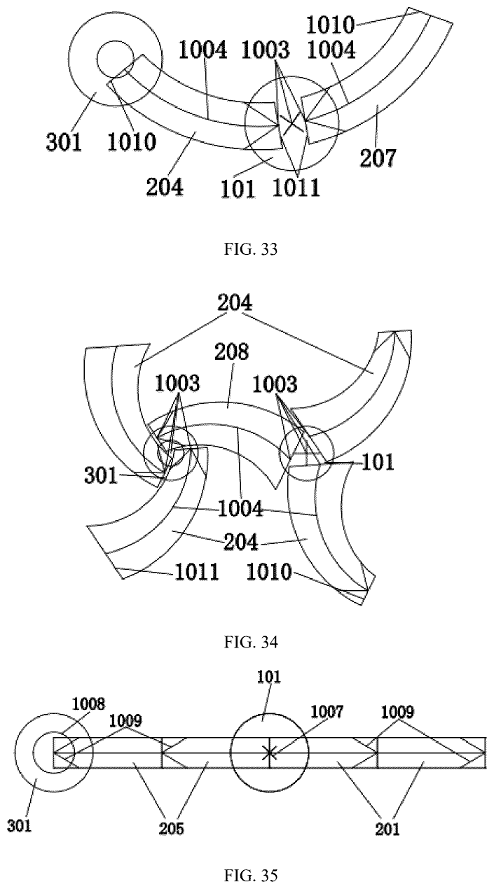

As shown in FIG. 33, a first substructure 101 and a third substructure 301 are coil structure units composed of two second substructures 2 with an arc-shaped arrangement of spiral centers 1004 with the same spiral outer diameter of 1010=1011. The spiral center 1003 of the third substructure 301 is located at the symmetrical center surrounded by the second substructures 2 symmetrically arranged with the same magnetic end. All spiral centers 1003 of the first substructure 101, the second substructure 2 and the third substructure 301 are connected in an arc. The second substructure 2 can be an arc-shaped second substructure plane spiral coil 202 with the same spiral outer diameter and the horizontal magnetic component to the left and an arc-shaped second substructure plane spiral coil 207 with the same spiral outer diameter and the horizontal magnetic component to the right.

### Embodiment 24

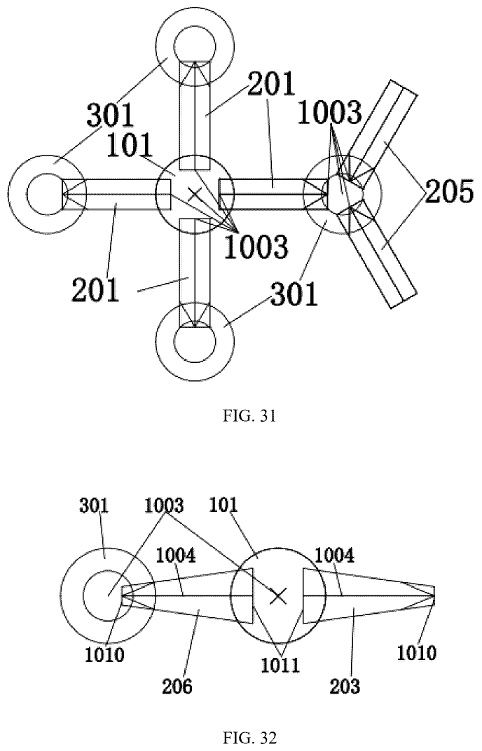

As shown in FIG. 31, it is a Helbeck array coil structural unit composed of multiple coils, a coil structural unit is formed by four third substructures 301, a first substructure 101 and six second substructures 2, where one third substructure 301 is located in the symmetrical center surrounded by three second substructures 2 symmetrically arranged at the same magnetic end, and the first substructure 101 is located in the symmetrical center surrounded by four second substructures 2 symmetrically arranged at the same magnetic end. The other two second substructures 2 connected with the third substructure 301 have unconnected end expansion interfaces, which can be expanded by using the coil expansion structure containing the first substructure 101. When expanding, it is necessary to refer to the spiral center position and the distance between the spiral centers of the third substructure 301 and the second substructure 2 to ensure the overall symmetry. The three peripheral third substructures 301 connected with the first substructure 101 can be used as expansion interfaces, and the coil expansion structure containing the second substructure 2 is used for expansion. When expanding, it is necessary to refer to the spiral center position and the distance between the spiral centers of the third substructure 301 and the second substructure 2 to ensure the overall symmetry. Where six second substructures 2 are composed of a linear second substructure plane spiral coil 201 with the same spiral outer diameter and the horizontal magnetic component to the right and a linear second substructure plane spiral coil 205 with the same spiral outer diameter and the horizontal magnetic component to the left.

### Embodiment 25

As shown in FIG. 34, a coil structure unit is formed by a first substructure 101, a third substructure 301 and five second substructures 2 with spiral center arc arrangement 1004 whose spiral outer diameter gradient increases or decreases by 1011>1010. The spiral centers 1003 of the first substructure 101 and the third substructure 301 are located in the center surrounded by the second substructures 2 symmetrically arranged with the same magnetic end center. The spiral centers 1003 of the first substructure 101, the middle substructure 2, and the third substructure 301 are not on the same arc. Where the second substructure 2 includes two types: an arc-shaped second substructure plane spiral coil 204 with a decreasing spiral outer diameter gradient of a rightward magnetic horizontal component, and an arc-shaped second substructure plane spiral coil 208 with a decreasing spiral outer diameter gradient and a leftward magnetic horizontal component.

### Embodiment 26

As shown in FIG. 35, a first substructure 101, a third substructure 301 and four second substructures 2 form a coil structure unit. The first substructure 101 and the third substructure 301 are connected with different magnetic ends of the two second substructures 2, where the second substructure 2 includes a linear second substructure plane spiral coil 201 with the same spiral outer diameter of a rightward magnetic horizontal component, and a linear second substructure plane spiral coil 205 with the same spiral outer diameter of a leftward magnetic horizontal component.

### Embodiment 27

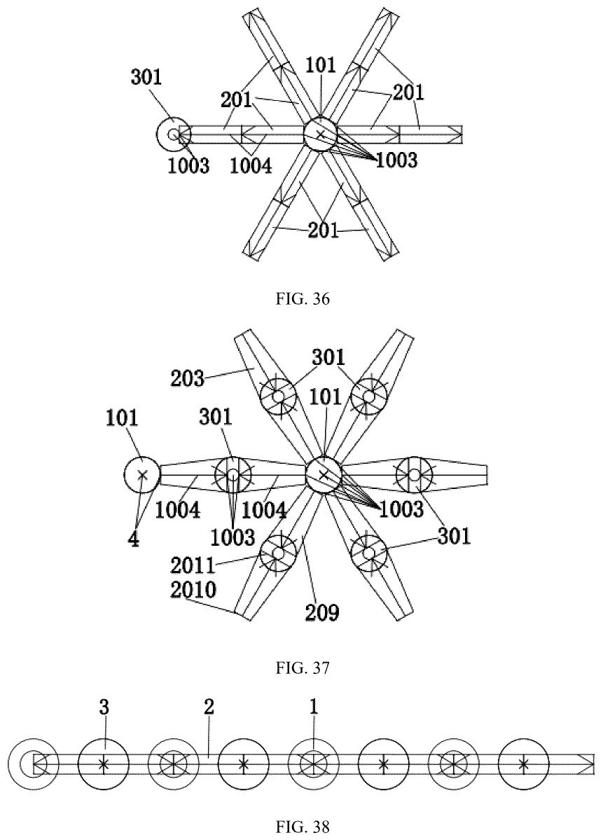

As shown in FIG. 36, a first substructure 101, a third substructure 301 and twelve second substructures 201 form a coil structure unit. The two second substructures 201 between the first substructure 101 and the third substructure 301 are connected with different magnetic ends, and five peripheral second substructures 201 have unconnected ends.

### Embodiment 28

As shown in FIG. 37, six first substructures 101, two third substructures 301 and twelve second substructures 2 with spiral center linear arrangement 1004 with spiral outer diameter gradient increasing or decreasing 1011>1010 form a coil structure units, and five peripheral second substructures 2 have unconnected ends. Where, the second substructure 2 includes a linear second substructure plane spiral coil 203 of a rightward magnetic horizontal component with decreasing spiral outer diameter gradient and a linear second substructure plane spiral coil 209 of a leftward magnetic horizontal component with increasing spiral outer diameter gradient.

### Embodiment 29

As shown in FIG. 38, a schematic diagram of the linear Helbeck array coil structural unit combination formed by self-connection and expansion of four structures shown in FIG. 30. In this embodiment, the second substructure 2 in the coil structure unit combination can be replaced by FIG. 2E and FIG. 2G.

### Embodiment 30

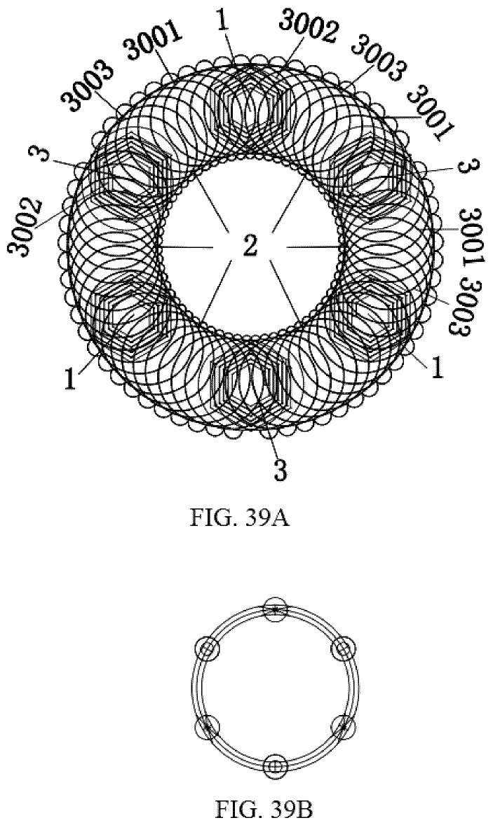

As shown in FIG. 39A-FIG. 39B, a three-layer linear closed-loop (circular) Helbeck array coil structure unit combination is formed by self-connection and expansion of three structures shown in FIG. 33, in which the second substructure 2 is a planar spiral coil with Z-shaped double-layer spiral centers arranged in an arc 1004, which is composed of an upper coil layer 1005 and a lower coil layer 1006 shown in FIG. 5B. The first substructure 101 and the third substructure 301 are single-layer concentric planar spiral coils, respectively. In FIG. 39A, the coil structure unit is divided into a first layer 3001, a second layer 3002 and a third layer 3003, and FIG. 39B is a schematic diagram of the magnetic direction of the coil combination. In this embodiment, a material filling layer can be added in the middle of the second substructure 2 with reference to FIG. 54 to improve the corresponding insulation performance, heat dissipation performance, magnetic conductivity performance and coil structure regularity performance of the coil structure unit combination. In addition, in this embodiment, the material filling layer can be arranged not only between layers, but also on the upper or lower layer of the coil which is laid flat, and the setting position is preferably located on the back magnetic surface (weak magnetic surface). The second substructure 2 of this embodiment can also replace the structure in FIG. 2F to form a hexagonal Helbeck array characteristic magnetic field with the corresponding magnetic surface on the upper or lower surface of the coil.

### Embodiment 31

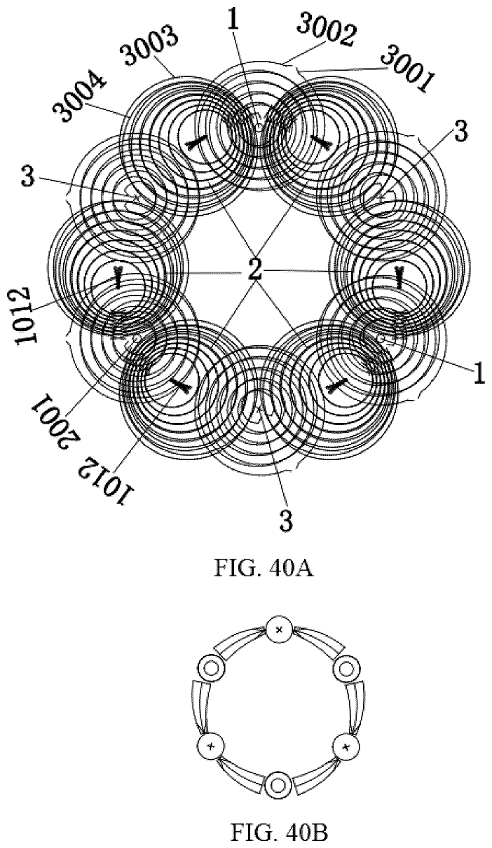

As shown in FIG. 40A-FIG. 40B, a four-layer linear closed-loop Helbeck array coil structure unit combination is formed by stacking six coil structure units in FIG. 1B arranged in a regular hexagon and six coil structure units in FIG. 4 arranged in a regular hexagon with different projection points staggered by 30 degrees between layers. Both FIG. 1B and FIG. 4 are double-layer coil structures consisting of an upper coil layer 1005 and a lower coil layer 1006 with opposite spiral directions. The layered coil structure unit in FIG. 40A includes a first layer 3001, a second layer 3002, a third layer 3003 and a fourth layer 3004, and FIG. 40B is a schematic diagram of the magnetic direction of the coil combination.

### Embodiment 32

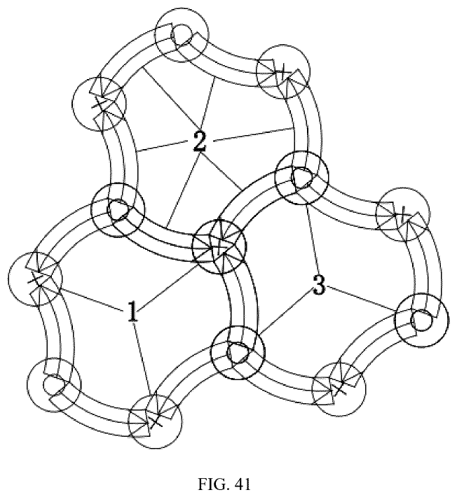

As shown in FIG. 41, a netted three-ring coil structure unit combination consisting of one coil structure unit shown in FIG. 34, six coil expansion structure first substructures 1, ten coil expansion structure second substructures 2 and five coil expansion structure third substructures 3 is expanded in a central symmetric manner. This structure forms three hexagonal magnetic rings, and only the first substructure 1 and the third substructure 3 connecting two second substructures 2 can be used as expansion points in this structure, and the second substructure 2 is used to continue to expand and form more hexagonal magnetic rings.

### Embodiment 33

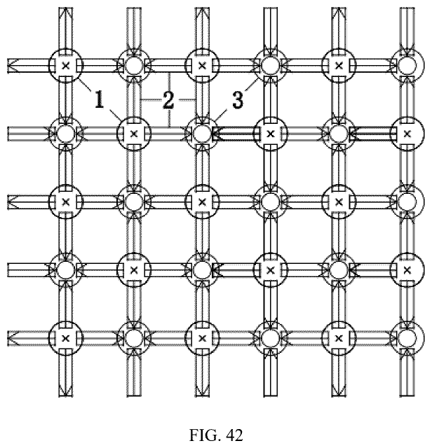

As shown in FIG. 42, it is a schematic diagram of the magnetic direction of the netted Helbeck array coil structure unit combination formed by arranging or stacking multiple first substructures 1, second substructures 2 and third substructures 3 according to the above coil position requirements. The coil structure unit combination can be applied to the magnetic suspension system after being electrified. In this embodiment, the second substructure 2 in the coil structure unit combination can be replaced by FIG. 2E, FIG. 2G and FIG. 5A.

### Embodiment 34

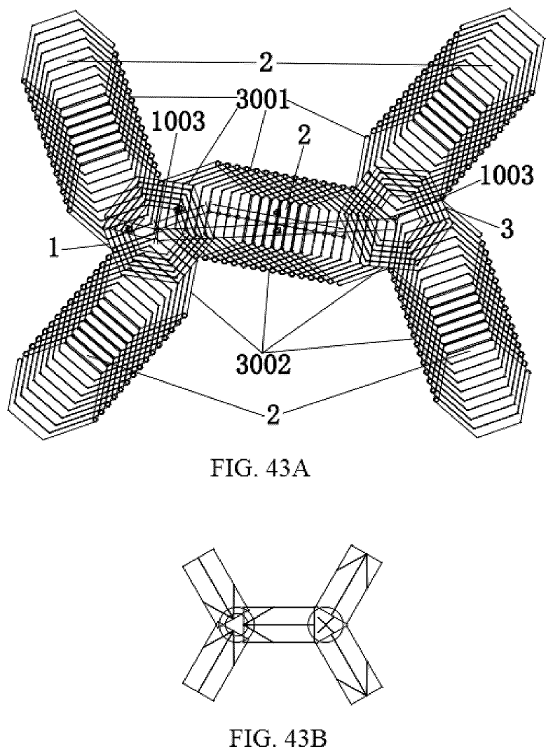

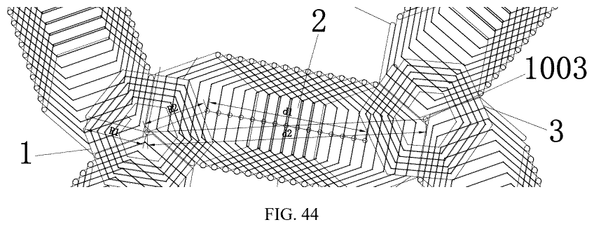

As shown in FIG. 43A-FIG. 43B and FIG. 44, it is a double-layer coil structure unit consisting of a single-layer hexagonal first substructure 1 coil, five double-layer second substructures 2 and a single-layer third substructure 3 in the stacking mode shown in FIG. 50. The spiral centers 1003 of the first substructure 1 and the third substructure 3 are located in the center surrounded by three second substructures 2 symmetrically arranged with the same magnetic end center, where the second substructure 2 is the double-layer coil structure shown in FIG. 2F. It consists of an upper coil layer 1005 and a lower coil layer 1006. FIG. 43A shows that the coil structure unit includes a first layer 3001 and a second layer 3002, and FIG. 43B is a schematic diagram of the magnetic direction of the coil combination. As shown in FIG. 44, R1 is the spiral outer diameter of concentric plane spiral coil; R2 is the short distance from that spiral center of concentric plane spiral coil to the end point of the connecting line of the spiral center of the second substructure 2002; d1 is the length of the connecting line of the spiral center of the second substructure; d2 the length of the connecting line between the spiral centers of the first substructure and the third substructure. Where, the shortest distance R2 from the spiral center of the concentric plane spiral coil to the end point of the second substructure spiral center line or the fitting line of the spiral center line symmetrically or centrally arranged with the same magnetic end preferably satisfies: R2<(1.618±0.05)R1, and R1 is the spiral outer diameter of the concentric plane spiral coil. As shown in FIG. 44, R2<(1.618±0.05)R1. When the spiral center of the concentric planar spiral coil is not at the end point of the spiral center line or spiral center line fitting line of the second substructure connected with one or more different magnetic ends, the ratio of the length of the spiral center line or spiral center line fitting line of the second substructure connected with one or more different magnetic ends to the length of the spiral center magnetic circuit connecting line of the first substructure and the third substructure preferably satisfy 0.618±5%, as shown in FIG. 43, 0.568≤d1/d2≤0.668.

### Embodiment 35

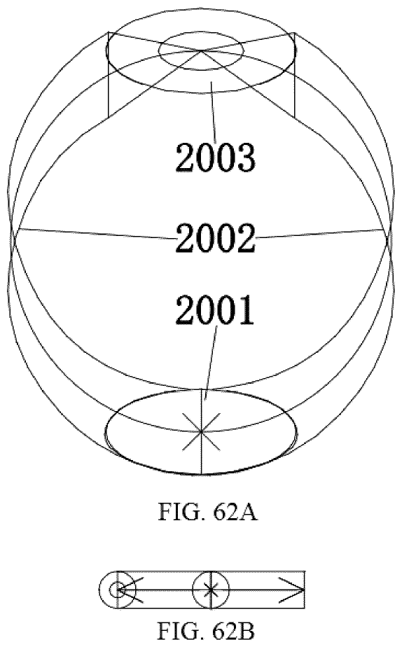

As shown in FIG. 62A, it is an annular three-dimensional coil structure unit combination formed by winding a coil structure unit of FIG. 30 with the first substructure 101 as the bottom and connecting the two sides into a circle. After the third substructure 301 is wound by 180 degrees, the vertical magnetic direction is consistent with the first substructure 101. The second substructure 201 transfers the magnetic circuit of the first substructure 101 to the third substructure 301, and the third substructure 301 transfers the magnetic circuit downward to the first substructure to form a magnetic circuit cycle. FIG. 62B shows the unwound coil structure. The structure can form an internal uniform magnetic field, and can also be applied to radial wireless power transmission, so that the magnetic leakage is significantly reduced and the power transmission efficiency is improved.

### Embodiment 36

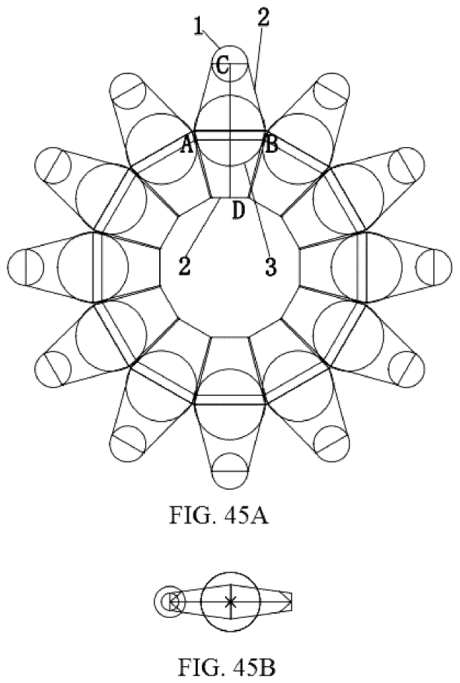

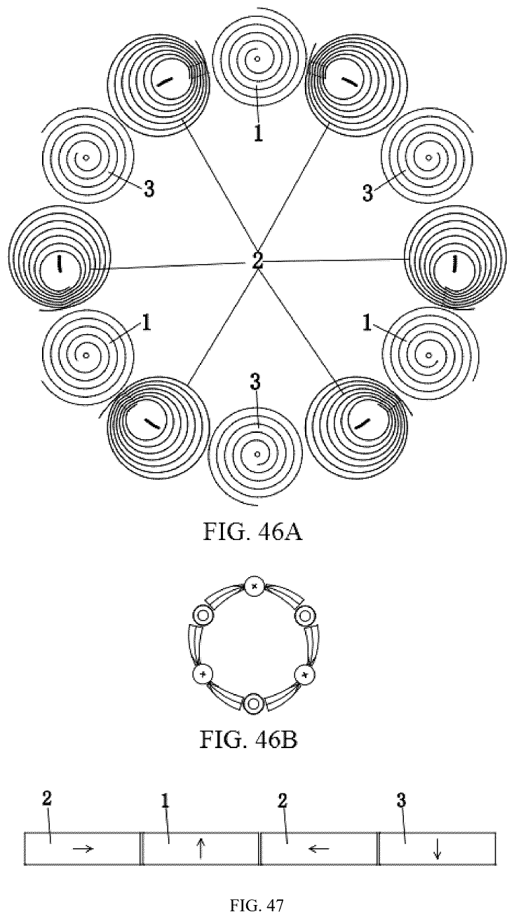

As shown in FIG. 45A-FIG. 45B, FIG. 45A is a coil structure combination formed by taking the coil structure unit in FIG. 45B as the array object and taking the center of a regular dodecagon as the array center. AB is the side of a regular dodecagon, CD is the connecting line of the spiral center of the coil structure unit of the array object, CD is perpendicular to the horizontal plane, AB is the tangent point of the spiral outer diameter of two adjacent third substructures 3, all 12 coil structure units are bent into a ring, and two points of CD coincide. A torus coil structure combination similar to a lifebuoy is formed. The vertical magnetic direction of the first substructure 1 is the same as that of the third substructure 3 after 180-degree winding. The second substructure 2 transfers the magnetic circuit of the third substructure 3 to the first substructure 1, and the first substructure 1 transfers the magnetic circuit downward to the third substructure 3 to form a cycle. The magnetic field is located in the torus ring, and the spiral center of the first substructure 1 points to the spiral center of the third substructure 3. The spiral center of the first substructure 1, the spiral center of the third substructure 3 and the center of the torus are in a straight line. In this coil structure combination, the second substructure of the array coil structure unit is replaced by the structure shown in FIG. 5A, and the spiral center of the first substructure 1, the spiral center of the third substructure 3 and the center of the torus are not in the same straight line.

### Embodiment 37

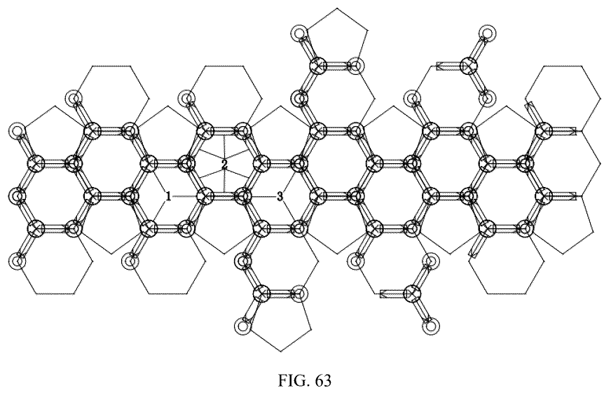

As shown in FIG. 63, it is a football-shaped Helbeck array coil structure unit combination development diagram formed by arranging or stacking 24 first substructures 1, 72 second substructures 2 and 36 third substructures 3 according to the coil position requirements. The football-shaped Helbeck array coil structure unit combination is a truncated icosahedron, with a total of 32 faces, where, 20 regular hexagons and 12 regular pentagons are glued to form football bodies. After laying coil structural units, internal surface magnetic fields, internal magnetic fields or external surface magnetic fields can be formed.

### Embodiment 38

As shown in FIG. 38, multiple coil structural unit combinations of FIG. 38 are stacked according to the coil surface to form a multi-layer coil structural unit combination, and the layers correspond to the magnetic ends, so as to further enhance the magnetic field intensity on the upper surface or the lower surface of the coil stacking surface, and a material filling layer can be added between the layers to improve the corresponding insulation performance, heat dissipation performance and magnetic conductivity energy of the coil structural unit combination.

### Embodiment 39

As shown in FIG. 38, the coil structural unit combination shown in FIG. 38 are self-connected from end to end to form a 360-degree annular coil structural unit combination, and the annular coil structural units with different annular internal diameter specifications are customized, nested together, and the layers correspond to the magnetic ends to form a magnetic field with magnetic surfaces inside or outside the ring. A radial flux motor/generator can be formed by using a single ring coil combination or a nested ring coil combination with a magnetic surface inside or outside the ring as a winding and a permanent magnet rotor. The frameless motor formed by the combination of circular coils with magnetic surfaces inside or outside the ring has a thinner coil winding structure. The ring coil combination with magnetic surface inside or outside the ring can also be used as the magnetic levitation bearing winding. A material filling layer can be added between layers to improve that corresponding insulation performance, heat dissipation performance and magnetic conductivity energy of the coil structural unit combination.

### Embodiment 40

As shown in FIG. 42, the coil structural unit combination shown in FIG. 42 is bent and wound into a cylinder, which is self-connected to form a closed loop, and the magnetic surface is located inside or outside the cylinder. The radial flux motor/generator can be formed by using the coil structural unit combination with magnetic surfaces inside or outside the cylinder as windings and matching with permanent magnet rotors.

### Embodiment 41

As shown in FIG. 46A, it is a single-layer Helbeck array planar coil structural unit composed of six diagrams A in FIG. 1A and six diagrams in FIG. 3, and FIG. 46B is a schematic diagram of the magnetic direction of the coil combination.

### Embodiment 42

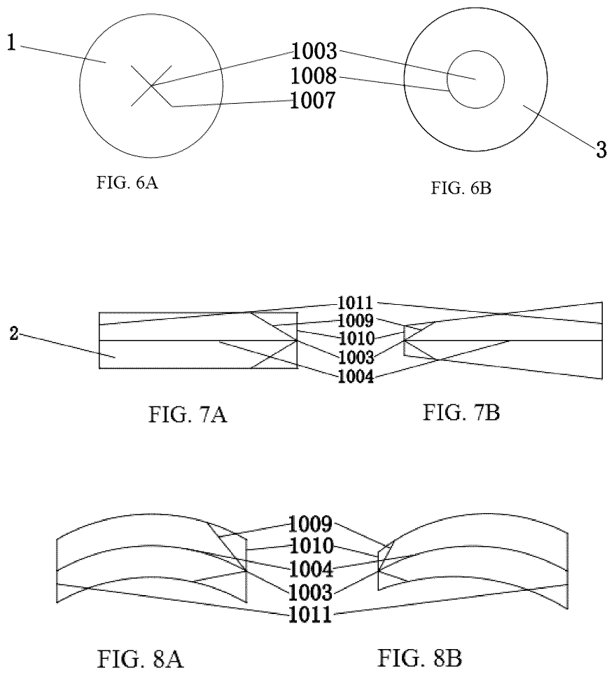

A first substructure 1 with vertical magnetic path downward is composed of at least one magnetic schematic diagram in FIG. 6A, at least two magnetic direction schematic diagrams of a second substructure 2 with equal spiral diameter in FIG. 7A or a second substructure 2 with increased or decreased spiral diameter in FIG. 7B or an arc-shaped second substructure with equal spiral diameter in FIG. 8A or a second substructure with increased or decreased spiral diameter in FIG. 8B, at least one schematic diagram of magnetic direction of the first substructure with a vertical upward magnetic path in FIG. 6B, form linear, folded or arc coil structural unit combination by arrangement or lamination according to the coil position requirements described above, which can be applied to linear, folded or arc electromagnetic guide rails after being electrified.

### Embodiment 43

A combination of linear or arc coil structural units formed by the structure of at least one magnetic schematic diagram in FIG. 6A, at least two magnetic schematic diagrams in FIG. 7A or FIG. 7B or FIG. 8A or FIG. 8B, and at least one magnetic schematic diagram in FIG. 6B, arranged or stacked according to the coil position requirements described above. Then, by bending, buckling, winding, nesting or stacking, a coil structural unit combination can be formed, and after being electrified, a three-dimensional structured Helbeck array characteristic magnetic field with a magnetic surface on the inner surface or the outer surface or the inner or outer surface or a three-dimensional structured Helbeck array characteristic magnetic field with a magnetic surface on the upper surface or the lower surface of the three-dimensional stacking surface can be formed, where the internal magnetic field includes a uniform magnetic field.

In the description of the disclosure, it should be understood that the azimuth or positional relationship indicated by the terms “longitudinal”, “transverse”, “upper”, “lower”, “front”, “rear”, “left”, “right”, “vertical”, “horizontal”, “top”, “bottom”, “inner” and “outer”. “vertical”, horizontal” is based on the azimuth or positional relationship shown in the attached drawings, only for the convenience of describing the disclosure, and does not indicate or imply that the devices or elements referred to must have a specific orientation, be constructed and operated in a specific orientation, so it cannot be understood as a limitation of the disclosure.

The above-mentioned embodiments only describe the preferred mode of the disclosure, and do not limit the scope of the disclosure. Under the premise of not departing from the design spirit of the disclosure, various modifications and improvements made by ordinary skilled in the field to the technical scheme of the disclosure shall fall within the protection scope determined by the claims of the disclosure.

What is claimed is:

1. Helbeck array planar coil structural units, comprising:
three types of substructures: first substructures, second substructures and third substructures;
wherein, the first substructures and the third substructures are concentric planar spiral coils with opposite magnetic circuits in a vertical direction after being electrified, and the second substructures are plane spiral coils of a spiral center linear arrangement with a horizontal component in a magnetic direction after being electrified; spiral center linear arrangement modes of the second substructures comprises a spiral center connecting line arrangement or a spiral center connecting line fitting line being a straight line or an arc arrangement; all spiral outer diameters in the second substructures are same or different; coil layerings of the first substructures, the second substructures and the third substructures comprise a single-layer planar spiral structure, a double-layer planar spiral structure and a multi-layer planar spiral structure;
coil position arrangement modes of the first substructures, the second substructures and the third substructures comprise:
spiral centers of the first substructures and the third substructures are located at both ends between coil spiral center connecting lines of the second substructures, and two or more the second substructures are centered on concentric plane spiral centers of the first substructures or the third substructures, and homomagnetic ends are symmetrical arrangement or centrally symmetric arrangement; or, spiral centers of the first substructures and the third substructures are respectively located at two end of a horizontal magnetic circuit formed by one or more the second substructures, and two or more substructures between two ends of a horizontal magnetic circuit formed by a plurality of the second substructures are heteromagnetic end arrangement;
modes of coil arrangement or lamination into a plane comprise:
firstly, the first substructures, the second substructures and the third substructures are single-layer planar spiral structures or double-layer planar spiral structures to arrange in a plane;
secondly, end points of connecting lines or fitting lines between spiral centers of the first substructures or the third substructures with double-layer planar spiral structures or multi-layer planar spiral structures and spiral centers of the second substructures are different, and projection points are stacked into a plane;
thirdly, end points of connecting lines or fitting lines between spiral centers of the first substructures or the third substructures with single-layer planar spiral structures and double-layer planar spiral structures, multi-layer planar spiral structures and spiral centers of the second substructures are different, and projection points are stacked into a plane;
fourthly, end points of connecting lines or fitting lines between spiral centers of the first substructures or the third substructures with single-layer planar spiral structures and double-layer planar spiral structures, multi-layer planar spiral structures and spiral centers of the second substructures are same, and projection points are stacked into a plane;
fifthly, end points of connecting lines or fitting lines between spiral centers of the first substructures or the third substructures with single-layer planar spiral structures and double-layer planar spiral structures, multi-layer planar spiral structures and spiral centers of the second substructures are same, and projection points laminate and combine material filling layers to form a plane;
composition of coil structural unit and magnetic field characteristics comprise:
plane spiral coils of one or more of the first substructures, the second substructures and the third substructures are stacked into a plane or more than two-layer thin-layer structure according to coil position arrangement modes, coil arrangement or lamination into a plane mode, all substructures are connected in series, parallel or series-parallel hybrid mode to form the Helbeck array coil structure units, and a Helbeck permanent magnet array characteristic magnetic field is formed after being electrified, wherein spiral centers of the first substructures and the third substructures are coil structure unit north and south poles respectively, and north and south poles at two ends of the second substructures and the first substructures and the third substructures form a magnetic circuit connection, and magnetic polarity of unconnected ends of the second substructures is opposite to that of connected ends; spiral central connecting line shapes of the planar coil structural units comprise a straight line, an arc and a net shape;
coil structural unit connection expansion modes comprise:
according to the coil position arrangement modes, the coil arrangement or lamination into a plane mode, connection expansion is performed through self-structure or connection expansion is performed through coil expansion structure;
a coil structure unit combination comprises linear and netted planar coil structure unit combination formed by self-structure connection expansion or coil expansion structure connection expansion, a planar coil structure unit combination formed by coil structure unit array or nesting, and a three-dimensional coil structure unit combination formed by coil structure unit bending or folding or winding or nesting or stacking;
wherein magnetic field characteristics of the coil structure unit combination comprise:
firstly, in-plane line and surface type characteristic magnetic field: linear, zigzag, circular, toroidal, arc-shaped, elliptical, polygonal, and netted plane Helbeck permanent magnet array characteristic magnetic field with magnetic surface located on upper or lower surface of coils;
secondly, three-dimensional structure characteristic magnetic field: Helbeck permanent magnet array characteristic magnetic field with magnetic surface located on inner surface or outer surface or inside or outside coils, and Helbeck permanent magnet array characteristic magnetic field with magnetic surface located on an upper surface or lower surface of a coil stacking surface; Helbeck permanent magnet array characteristic magnetic field with magnetic surface located inside coils comprises uniform magnetic field;
insulating materials, or heat dissipation materials, or heat dissipation pipelines, or magnetic conductive materials are stacked or filled above or below or between layers the coil structural units and combinations thereof, so as to improve corresponding insulation performance, heat dissipation performance, magnetic conductivity performance and coil structural regularity performance of the coil structural units;
the coil structural units and combinations thereof are made by printed circuit board method or planar coil splicing method.

2. The Helbeck array planar coil structural units according to claim 1, wherein in the coil position arrangement modes, spiral center positions of the first substructures or the third substructures comprise end points of a spiral center connection line or a spiral center connection line fitting line or extension line thereof located in one or more the second substructures with heteromagnetic end connection, or a center surrounded by more than two the second substructures with homomagnetic end being symmetrical arrangement or centrally symmetric arrangement.

3. The Helbeck array planar coil structural units according to claim 1, wherein according to the coil position arrangement modes, coil arrangement or lamination into a plane mode, connection expansion being performed by self-structure or coil expansion structure comprises: insertion and expansion of the second substructures in same horizontal magnetic circuit with the first substructures or the third substructures as expansion points and unconnected ends of the second substructures as expansion points; insertion and expansion of the second substructures in same horizontal magnetic circuit, and insertion and expansion of the second substructures in heteromagnetic end arrangement mode; the coil expansion structures comprise the first substructures, the second substructures, the third substructures, the first substructures or combinations of the first substructures or the third substructures with one or more the second substructures, combinations of the first substructures and the third substructures with zero to a plurality of the second substructures.

4. The Helbeck array planar coil structural units according to claim 1, wherein the second substructures have a magnetic circuit transmission function, magnetic circuit transmission comprises equal flux density transmission and flux density convergence/divergence transmission; all spiral outer diameters of the second substructures are different, comprising spiral outer diameters first increasing and then decreasing, gradient increasing or decreasing.

5. The Helbeck array planar coil structural units according to claim 1, wherein second substructure coil layering comprises a single-layer planar spiral structure, a double-layer planar spiral structure and a multi-layer planar spiral structure, wherein the single-layer planar spiral structure is planar spiral coils with linear arrangement of spiral centers of each of spiral units, and the double-layer planar spiral structure is formed by connecting single-layer planar spiral coils with linear arrangement of spiral centers with opposite spiral directions in series or in parallel with same direction, or each of the spiral units is a Z-shaped double-layer planar spiral structure formed by combining an upper ring layer and a lower ring layer; the multi-layer planar spiral structure comprises a plurality of single-layer planar spiral structures or a plurality of double-layer planar spiral structures in series, parallel or series-parallel combination, or each of the spiral units is a rotating stepped multi-layer planar spiral structure formed different coil layers; and interlayer gaps in the double-layer planar spiral structure or the multi-layer planar spiral structure are filled with insulating materials, heat dissipation materials, heat dissipation pipelines or magnetic conductive materials.

6. The Helbeck array planar coil structural units according to claim 5, wherein each of the spiral units has a Z-shaped double-layer planar spiral structure formed by combining an upper coil layer and a lower coil layer, the upper coil layer and the lower coil layer are respectively planar, spiral centers of all the spiral units are arranged in a linear way, planar projection of the upper coil layer and the lower coil layer of each of the spiral units surrounds a geometric figure, and plane projections of a head end of the upper coil lay and a tail end of the lower coil lay are not coincident; a tail end of an upper coil lay of the spiral unit is connected with a head end of a low coil layer of the spiral unit through an interlayer, and a tail end of a lower coil lay of the spiral unit is connected with a head end of an upper coil layer of a next spiral unit through an interlayer connection, and so on to form a Z-shaped double-layer planar spiral structure with a spiral center linear arrangement, wherein one end of a lower coil layer is vacant and an other end of an upper coil layer is vacant;
Z-shaped double-layer planar spiral structure with a spiral center linear arrangement is electrified to form a characteristic magnetic field structure with non-zero horizontal magnetic vector component; the geometric figure comprises a closed geometric figure formed by continuous connection of one end of plane projections of the upper and lower coil layers and crossing of an other end, and an open geometric figure formed by continuous connection of one end of the plane projections of the upper and lower coil layers and non-crossing of the other end; the geometric figure comprises polylines, polygons, circular arcs, and a combination of polygons and circular arcs; the interlayer connection comprises vertical connection and connection through phase-shifting parts, and the upper coil layer vacancy projection area S1 and the lower coil layer vacancy projection area S2 are same and different.

7. The Helbeck array planar coil structural units according to claim 5, wherein each of the spiral units is a rotating stepped multi-layer planar spiral structure comprising different coil layers, each of the spiral units of the coil comprises a plurality of layers, each of the layers has a section of conductor, a spacing between adjacent layers is equal, each of the layers forms a plane respectively, spiral centers of all the spiral units are arranged in a linear way, and plane projections of each of the layers of conductor forms a geometric figure, plane projections of a head end of a first lay conductor and that of a tail end of a last layer conductor are not coincident, and a tail end of the first lay conductor is connected with a head end of a next layer conductor of the spiral unit through an interlayer connection; a tail end of the next layer conductor of the spiral unit is connected with a head end of a next layer conductor of the spiral unit through interlayer connection, and so on, until a tail end of a last layer conductor is connected with a head end of a head layer conductor of a next spiral unit through interlayer connection, and finally a rotating stepped multi-layer planar spiral structure of spiral center linear arrangement with a lower part of one end being vacant and an upper part of an other end being vacant is formed; the rotating stepped multi-layer planar spiral structure of spiral center linear arrangement is electrified to form a characteristic magnetic field structure with non-zero horizontal magnetic vector component, and the geometric figure comprises a closed geometric figure formed by planar projection of a head end of the first layer conductor and a tail end of a last layer conductor intersecting but not overlapping and plane projections of other layers conductor being continuously connected, and an opening geometry figure formed by plane projections of the head end of the first layer conductor and the tail end of the last layer conductor intersecting and the plane projection of the other layers conductor being continuously connected; the geometric figure comprises polygons, circular arcs, and a combination of polygons and circular arcs, the interlayer connection comprises vertical connection and connection through phase-shifting parts, an upper vacant projection area S3 and a lower vacant projection area S4 are same and different.

8. The Helbeck array planar coil structural units according to claim 5, wherein a layer spacing a between adjacent layers of the double-layer planar spiral structure or the multi-layer planar spiral structure and a conductor diameter or thickness d0 preferably satisfy:
when working frequency f≤10 kHz, a=(0.8d0+Δa)±0.1 mm;
when 10 kHz<f≤1 MHz, a=(1.1d0+Δa)±0.05 mm;
when f>1 MHz, a=(0.6d0+Δa)±0.03 mm;
wherein Δa is a thickness of a composite insulating layer and satisfies 0.05 mm≤Δa≤0.2 mm.

9. The Helbeck array planar coil structural units according to claim 1, wherein a shortest distance R2 of end points of a connecting line or a connecting line fitting line between spiral centers of the first substructures or the third substructures and spiral centers of the second substructures preferably satisfies: R2<(1.618±0.05)R1, and R1 is spiral outer diameter of the first substructures or the third substructures.

10. The Helbeck array planar coil structural units according to claim 1, wherein when spiral centers of the first substructures or the third substructures are not at end points of the spiral center connection line or spiral center connection line fitting line of one or more the second substructures connected with heteromagnetic end connection, a ratio of a length of a spiral center connection line or a spiral center connection line fitting line of same one or more second substructures with heteromagnetic end connection to a length of magnetic circuit connection line of spiral centers of the first substructures and the third substructures preferably satisfies 0.618+/−5%.

11. The Helbeck array planar coil structural units according to claim 1, wherein planar coil structural units are combined and electrified to form a Helbeck permanent magnet array characteristic magnetic field, the Helbeck permanent magnet array characteristic magnetic field comprises linear, polygonal, annular and planar Helbeck permanent magnet array characteristic magnetic fields with magnetic surfaces above or below, polygonal, annular, cylindrical, conical, polyhedral and spherical Helbeck permanent magnet array characteristic magnetic fields with magnetic surfaces located on inner surfaces or outer surfaces, and the Helbeck permanent magnet array characteristic magnetic fields with magnetic surfaces located on the inner surfaces comprise internal uniform magnetic fields.

12. The Helbeck array planar coil structural units according to claim 1, wherein bending or folding plane coil structural units are combined and electrified to form a Helbeck permanent magnet array characteristic magnetic field; the Helbeck permanent magnet array characteristic magnetic field with magnetic comprises polygonal, polygonal cylindrical, annular, cylindrical, spherical, toroidal and polyhedral Helbeck permanent magnet array characteristic magnetic fields with magnetic surfaces located on inner surfaces or outer surfaces; and the Helbeck permanent magnet array characteristic magnetic fields with magnetic surfaces located on the inner surfaces comprise internal uniform magnetic fields.

13. The Helbeck array planar coil structural units according to claim 1, wherein two or more planar coil structural units not externally connected with the second substructures are connected with a magnetic end by spiral centers of the first substructures or a plane point surrounded by the first substructures to form planar strong magnetic points, wherein the planar strong magnetic points comprise spiral centers of the first substructures or a plane point surrounded by the first substructures, and formed planar strong magnetic points comprise a magnetic flux density convergence/divergence vortex strong magnetic point; a combination of planar strong magnetic point coils is connected into a ring and a sphere by bending, and magnetic surface is located inside, after being electrified, a smallest circular Helbeck permanent magnet array internal uniform magnetic field and a smallest spherical Helbeck permanent magnet array internal uniform magnetic field are formed.

14. The Helbeck array planar coil structural units according to claim 1, a planar, polygonal cylindrical, cylindrical, spherical and annular Helbeck array planar coil network combination comprising a plurality of Helbeck array planar coil structural units is electrified to form a Helbeck permanent magnet array characteristic magnetic field structure, being applied to construction of magnetic shielding surfaces and magnetic shielding spaces.

15. The Helbeck array planar coil structural units according to claim 1, wherein a polyhedral Helbeck array planar coil network combination comprising a plurality of Helbeck array planar coil structural units is electrified to form a Helbeck permanent magnet array characteristic magnetic field structure, being applied to construction of magnetic shielding surfaces and magnetic shielding spaces.

16. The Helbeck array planar coil structural units according to claim 1, wherein the heat dissipation material is preferably a shape memory alloy (SMA) heat pipe structure, and the magnetic conductive material is preferably a magnetic conductive material with relative permeability being ≥100 μ0 or effective relative permeability of magnetorheological magnetic conductive material being ≥100 μ0 when external electric field intensity is 2-5 kV/mm.

17. The Helbeck array planar coil structural units according to claim 1, wherein the Helbeck array plane coil structural unit combination is applied to magnetic resonance, electromagnetic accelerator, particle accelerator, detector, magnetic levitation, motor and generator, electromagnetic sensor, magnetic energy storage, wireless power transmission, electromagnetic shielding, magnetic therapy device, electromagnetic detection, electromagnetic molding, electromagnetic ultrasonic transducer, magnetic separation and electromagnetic stirring.

18. The Helbeck array planar coil structural units according to claim 1, wherein the coil structure units and combination thereof are made by printed circuit board method or planar coil splicing method; the printed circuit board method preferably adopts HDI process, with line width/line spacing ≤50 μm, blind hole diameter ≤100 μm and interlayer alignment error ≤5 μm; the planar coil splicing method is preferably laser welding or nano-silver paste conductive adhesive welding.
